(19) United States
(12) Patent Application Publication
(10) Pub. No.: US 2025/0244177 A1
(43) Pub. Date: Jul. 31, 2025

(54) BOLOMETER-OPTICAL MICRORESONATOR INFRARED SENSOR AND DETECTING RAPID CHANGES IN THE INTENSITY OF INFRARED OR FAR-INFRARED LIGHT

(71) Applicant: Government of the United States of America, as represented by the Secretary of Commerce, Gaithersburg, MD (US)

(72) Inventors: Erich Nathan Grossman, Golden, CO (US); Scott Brian Papp, Boulder, CO (US); Michelle Sharon Eisgruber Stephens, Boulder, CO (US); Travis Crain Briles, Boulder, CO (US)

(21) Appl. No.: 19/042,795

(22) Filed: Jan. 31, 2025

Related U.S. Application Data
(60) Provisional application No. 63/627,469, filed on Jan. 31, 2024.

(51) Int. Cl. G01J 5/08; G01J 5/02; G01J 5/0818; G01J 5/20

(52) U.S. Cl. CPC G01J 5/0896; G01J 5/0205; G01J 5/0818; G01J 5/20

(57) ABSTRACT

A bolometer-optical microresonator infrared sensor includes a frame; at least two legs mechanically supporting an island to the frame, with a ridge patterned into each leg forming a waveguide; a microresonator located on the island including a closed loop ridge waveguide; an absorber on the island separated from the microresonator; a waveguide coupler on the island connecting the waveguide on each leg to the microresonator; a waveguide transition on the frame at an end of each leg transmitting light between the waveguide on the leg and a waveguide supported by a substrate; and an edge coupler at an end of the substrate-supported waveguide.

### CROSS-REFERENCE TO RELATED APPLICATION

This application claims the benefit of U.S. Provisional Patent Application Ser. No. 63/627,469 (filed Jan. 31, 2024), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BACKGROUND

The present invention generally relates to the field of infrared and far-infrared sensors, and more particularly to techniques for detecting rapid changes in the intensity of infrared or far-infrared light.

Infrared (IR) sensors play a crucial role in diverse applications, from thermal imaging and spectroscopy to remote sensing and medical diagnostics. Existing technologies for detecting rapid changes in IR intensity, however, often face limitations in terms of speed, sensitivity, or complexity. Traditional bolometers, for example, while offering reasonable sensitivity, are inherently limited in their response time due to the thermal nature of their detection mechanism. This speed limitation can be a significant barrier in applications requiring high-bandwidth detection, such as free-space optical communication, time-resolved spectroscopy, or high-speed thermal imaging. Furthermore, many current high-speed IR detectors rely on complex and expensive fabrication processes or require cryogenic cooling to achieve optimal performance. These factors can significantly increase the cost and complexity of the sensor systems, limiting their accessibility for widespread adoption. Antenna-coupled detectors, for example, while offering high speed, often suffer from low sensitivity, particularly in the far-infrared region. Similarly, semiconductor-based photodetectors, although offering both speed and sensitivity in certain wavelength ranges, typically require cryogenic cooling for optimal performance in the far-infrared region.

The development of room-temperature, high-speed, and highly sensitive IR detectors remains an active area of research, with significant efforts focused on exploring novel materials and device architectures. Photonic devices, in particular, have emerged as promising candidates, offering the potential to overcome the limitations of conventional technologies. Optical microresonators, with their high quality factors and strong light-matter interaction, have demonstrated exceptional sensitivity for various sensing applications, but their integration with bolometric detection for high-speed IR sensing has remained largely unexplored.

It is therefore an objective of the present invention to provide a novel IR sensor architecture that combines the high sensitivity of bolometric detection with the speed and design flexibility of optical microresonators, thereby overcoming the above-mentioned disadvantages of the prior art at least in part. Accordingly, methods and equipment for using micromachined silicon nitride structures with integrated photonic waveguides and optical microresonators would be advantageous and would be favorably received in the art.

### BRIEF DESCRIPTION

One aspect of the present invention relates to a bolometer-optical microresonator infrared sensor. A bolometer is a type of thermal radiation detector that measures incident power by detecting a temperature change. An optical microresonator is a structure that confines light within a small volume, enhancing light-matter interaction.

It may be provided that the sensor includes a frame. This arrangement provides mechanical support and a stable platform for mounting other components. One advantage of using a frame is enhanced robustness and resistance to mechanical stress and vibrations, which can improve long-term stability.

It may be provided that the sensor includes at least two legs mechanically supporting an island to the frame, wherein a ridge is patterned into each leg forming a waveguide. This arrangement provides both mechanical support for the island and a pathway for optical signals. One advantage of using legs is thermal isolation of the island from the surrounding frame, which increases the sensor's sensitivity by reducing thermal noise and increasing the temperature change for a given incident power. One advantage of integrating the waveguide directly into the support legs is to miniaturize the sensor and reduce fabrication complexity, as compared to using separate waveguides.

It may be provided that the sensor includes a microresonator located on the island comprising a closed loop ridge waveguide. This arrangement confines light within a small volume, thereby increasing the interaction between the light and the microresonator material. One advantage of using a high-quality-factor microresonator is enhanced sensitivity to changes in temperature, refractive index, or absorbed power. This sensitivity translates directly to improved sensor performance.

It may be provided that the sensor includes an absorber on the island, separated from the microresonator. This arrangement allows incident infrared radiation to be absorbed, thereby raising the temperature of the island and, consequently, the microresonator. One advantage of separating the absorber from the microresonator is to avoid perturbing the optical properties of the microresonator, which would negatively impact its quality factor and sensitivity.

It may be provided that the sensor includes a waveguide coupler on the island for connecting a waveguide on each leg to the microresonator. This arrangement allows light from an external source to be coupled into the microresonator. One advantage of carefully designing the gap between the waveguide coupler and the microresonator is optimization of the coupling efficiency. This arrangement can enhance sensor performance.

It may be provided that the sensor includes a waveguide transition on the frame located at an end of each leg for transmitting light between the waveguide on the leg and a waveguide supported by a substrate. This arrangement allows optical signals to be efficiently coupled between the freestanding waveguides on the legs and the substrate-supported waveguides on the frame. One advantage of such transitions is reduced signal loss during coupling. Reduced loss improves the sensor's signal-to-noise ratio.

It may be provided that the sensor includes an edge coupler at an end of the substrate-supported waveguide. This arrangement provides a convenient means of coupling light into and out of the sensor using standard optical fibers or other components. One advantage is simplified integration of the sensor into larger optical systems.

One aspect of the present invention relates to a process for detecting rapid changes in the intensity of infrared or far-infrared light. Infrared light is electromagnetic radiation with wavelengths longer than those of visible light but shorter than those of radio waves. Far-infrared light occupies the longest wavelengths in the infrared spectrum.

It may be provided that the process includes providing a bolometer-optical microresonator infrared sensor. A bolometer is a sensitive thermal detector that measures incident power by detecting changes in temperature. An optical microresonator enhances light-matter interaction, increasing the sensitivity of the sensor. One advantage of this arrangement is that the sensor itself is capable of rapid response, limited by the speed of light rather than a thermal effect. One advantage of this combination is enhanced sensitivity, leveraging the microresonator's ability to amplify small changes in temperature or absorbed power.

It may be provided that the process includes providing a tunable continuous wave laser emitting light at a selected wavelength, e.g., near 1.55 μm. A tunable laser allows the emission wavelength to be precisely adjusted. Continuous wave operation provides a stable optical signal. One advantage of this arrangement is that using a continuous wave laser reduces noise, thereby enhancing sensitivity. A wavelength of 1.55 μm corresponds to the low-loss telecommunications band, readily available from commercial laser sources, thus reducing system complexity and expense.

It may be provided that the process includes coupling light from the laser to an input waveguide of the sensor. A waveguide confines and directs the light, minimizing loss and ensuring efficient delivery of the optical signal to the microresonator. One advantage of this arrangement is that using a waveguide to transmit the laser light minimizes the possibility of coupling the laser light into anything other than the input waveguide.

It may be provided that the process includes tuning the laser such that an emission line of the laser lies on the blue wing of a resonance line of a microresonator. A resonance line corresponds to a specific frequency or wavelength at which the microresonator strongly absorbs light. The blue wing refers to the higher-frequency side of the resonance line. One advantage of this arrangement is maximizing sensitivity to changes in the microresonator's resonance frequency due to incident IR radiation, since the slope of the resonance line is steepest on the wings. Positioning the laser on the blue wing provides increased stability due to negative photothermal feedback.

It may be provided that the process includes providing a photodetector, e.g., a photodiode, at an output of an output waveguide of the sensor. A photodiode converts light into an electrical signal, enabling detection and measurement of changes in light intensity. One advantage of this arrangement is converting the optical signal at the output waveguide into an easily measured electrical signal, allowing direct detection of changes in the light intensity transmitted through the microresonator.

It may be provided that the process includes exposing the sensor to infrared or far-infrared light whose intensity changes are to be measured. This arrangement allows the sensor to detect the incident IR radiation, causing a temperature change on the island that shifts the resonance frequency of the microresonator. This change in resonance frequency in turn changes the output signal of the laser transmitted by the output waveguide.

It may be provided that the process includes detecting changes in light intensity at the output waveguide with the photodiode, wherein the changes are indicative of changes in intensity of the infrared or far-infrared light. This arrangement translates changes in the resonance frequency of the microresonator into a readily detectable electrical signal, enabling the measurement of rapid changes in IR intensity. One advantage of this process is the inherent speed of the microresonator's optical response, as compared with the much slower response times of conventional thermal detectors, which enables high-bandwidth detection.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, a bolometer-optical microresonator infrared sensor wherein a single pixel includes a suspended island with optical microresonator and frequency selective surface (FSS) IR absorber, support legs with optical waveguide and Si frame providing mechanical support and optical routing layers.

FIG. 2 shows, according to some embodiments, support legs and relevant waveguide dimensions for bolometer-optical microresonator infrared sensor shown in FIG. 1, with width w1 of the waveguide and non-waveguide support legs; width w2 of the ridge that bounds the optical waveguide; and length L of the waveguide and non-waveguide legs.

FIG. 3 shows, according to some embodiments, bright and dark pixels for ambient correction, including edge couplers for input and output of the waveguided laser light from the bright and dark pixels.

FIG. 4 shows, according to some embodiments, a perspective view of a two-chip architecture for a bolometer-optical microresonator infrared sensor array.

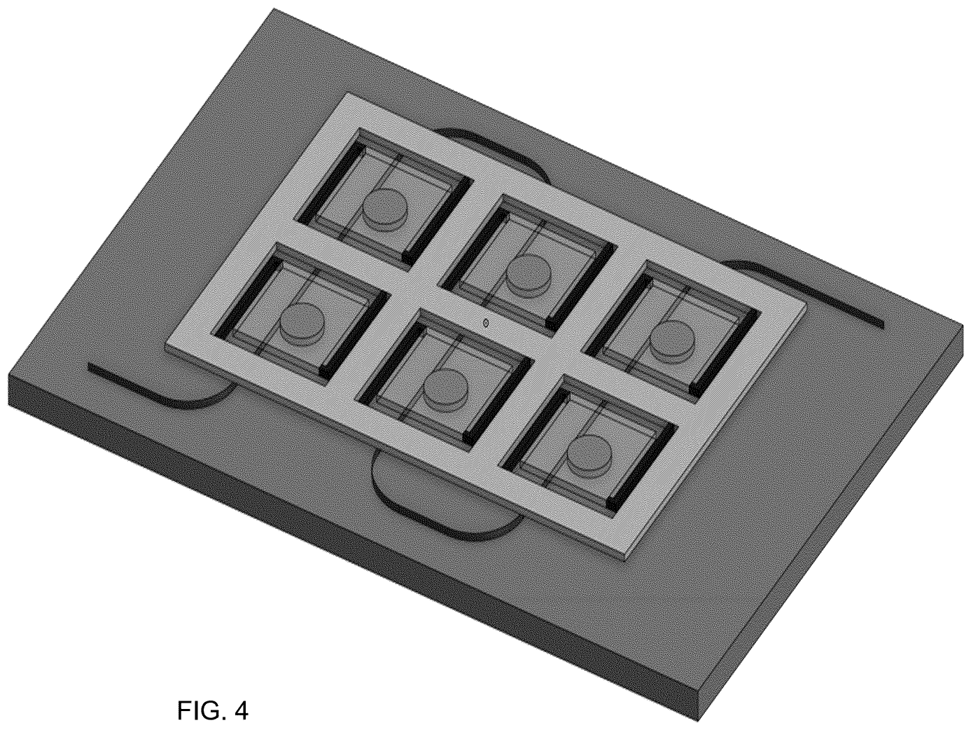

FIG. 5 shows, according to some embodiments, a side view of the two-chip architecture for a bolometer-optical microresonator infrared sensor array shown in FIG. 4.

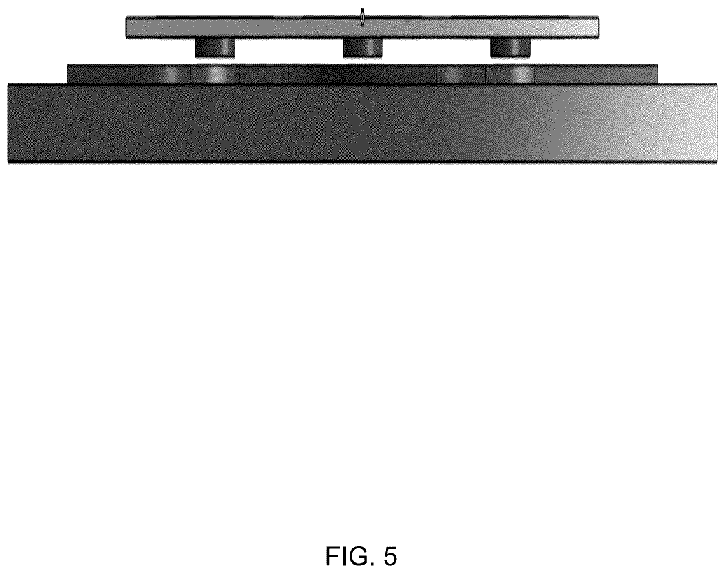

FIG. 6 shows, according to some embodiments, a perspective view of the two-chip architecture for a bolometer-optical microresonator infrared sensor array shown in FIG. 4.

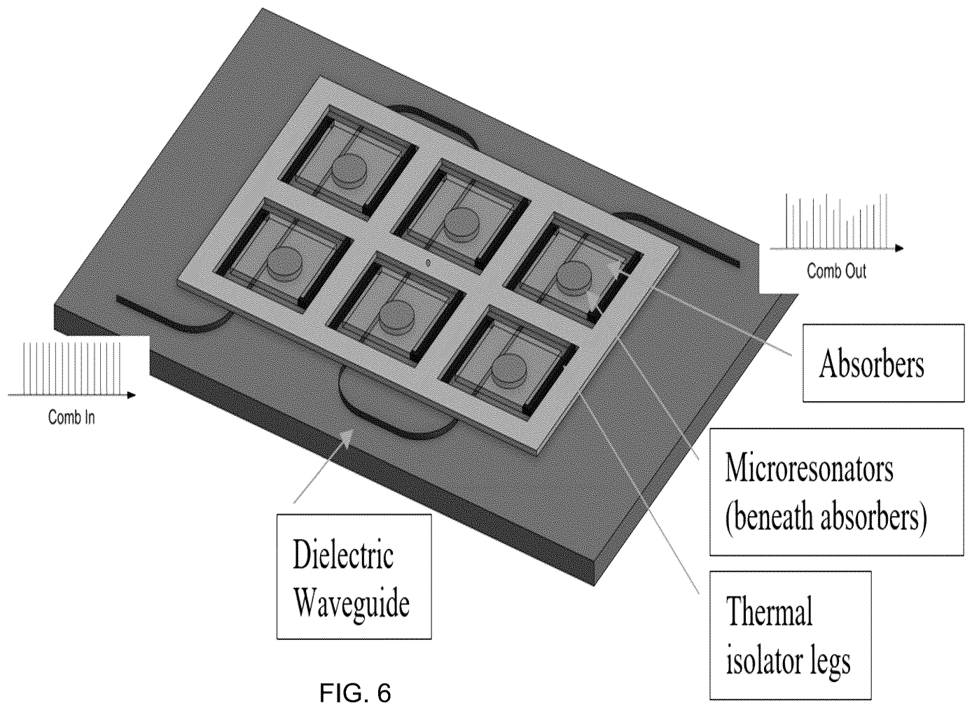

FIG. 7 shows, according to some embodiments, fabrication steps on the island with relevant steps and materials for making the bolometer-optical microresonator infrared sensor.

FIG. 8 shows, according to some embodiments, system architecture with operation of bolometer-optical microresonator infrared sensor, also referred to as OMBolo. Here, thermal IR is absorbed on the island, increases the temperature (i) of the optical mode volume of a microresonator (ii) and leads to a shift in the optical resonant frequency via thermorefractive effect (iii). The microresonator is temperature sensitive through the thermorefractive coefficient of its core material (approx. 12 part per million/K for Si₃N₄), leading to a redshift in optical resonant frequency when heated, appearing as a thermally induced redshift of resonant frequency in a microresonator.

FIG. 9 shows, according to some embodiments, incorporation of a dual-island pixel into a full system. The sidebands of the modulated laser are coupled to two separate, thermally isolated microresonators. One microresonator (bright pixel) is exposed to the incident light, and the other is not. Because of the higher power directed to the bright pixel, its resonance is shifted to the red (lower frequency) and distorted into an asymmetric and hysteretic lineshape by photothermal feedback. This dual-island architecture increases stability against ambient temperature and other environmental fluctuations.

FIG. 10 shows, according to some embodiments, a zoom-in of frequency space around a single resonance and comb tooth.

FIG. 11 shows, according to some embodiments, a model of the device physics based on the two-reservoir thermal circuit.

FIG. 12 shows, according to some embodiments, speedup produced by photothermal feedback (PTF). (a) laser-microresonator tuning curves for weak (i), moderate (ii), and strong (iii) PTF cases corresponding to normalized laser power powers of d=0.05, 0.5 and 5 respectively. (b) The temporal responses to a step increase in IR power at red and blue bias tunings (indicated as stars on the tuning curves) for the three cases as in (a). (c) Effective bolometer time constant as a function of laser power for blue laser detunings (with PTF, circles) and red laser detunings (without PTF, squares). In the limit of high laser power, the time constant approaches the limit τ=τ₂/4d (blue dashed line). The parameters used for (c) are shown on the bottom.

FIG. 13 shows, according to some embodiments, noise-equivalent power and time constant for a “phase 2” OMBolo with island area of 20×20 μm2. “Normalized laser power” is the dimensionless loop gain for photothermal feedback. Not that best sensitivity (minimum NEP) and best speed (minimum time constant) can be achieved in the same device, simply by adjusting the laser power.

FIG. 14 shows, according to some embodiments, SiN microresonators with quality factors approaching 10 million, suspended SiN membranes, and frequency selective surfaces. a) SiN microresonators with (b) quality factors approaching 10 million, (c) suspended 100 nm thick SiN membranes with d×d=80 μm×80 μm and tether dimensions of w=5 μm×L=850 μm, and (d) frequency selective surfaces for the optical domain fabricated from crossed slots in Ti/Au, demonstrating capabilities on SiN membranes.

### DETAILED DESCRIPTION

A detailed description of one or more embodiments is presented herein by way of exemplification and not limitation.

Conventional infrared and far-infrared sensors often suffer from limitations in speed and sensitivity, particularly at room temperature. Traditional bolometers, while offering good sensitivity, are inherently slow due to the thermal nature of their detection mechanism. High-speed detectors, such as antenna-coupled devices or semiconductor photodetectors, frequently require complex fabrication or cryogenic cooling, increasing cost and complexity. Existing microbolometer arrays used in thermal imaging often employ metal interconnects for readout, which creates thermal shorts, thus limiting sensitivity.

The bolometer-optical microresonator infrared sensor described herein overcomes these limitations by combining the sensitivity of bolometric detection with the speed of optical microresonators and eliminating metallic readouts. It has been discovered that a bolometer-optical microresonator infrared sensor uniquely leverages photothermal feedback for enhanced performance. One advantage is improved sensitivity. The sensor's all-dielectric support legs minimize thermal conductance, significantly enhancing thermal isolation of the island and, consequently, improving the sensor's response to small changes in incident IR power. This design enables a higher temperature change for a given incident power, ultimately increasing sensitivity. Another advantage is increased speed. The integration of an optical microresonator with exceptionally high quality factor enables rapid detection of temperature changes on the island. This arrangement significantly improves the sensor's response time, overcoming the inherent speed limitations of conventional bolometers. The photothermal feedback inherent in coupling a microresonator to a waveguide increases sensor bandwidth even further without compromising sensitivity. Another advantage is simplified readout and multiplexing. The optical readout mechanism eliminates the need for electrical interconnects to the island, allowing even greater thermal isolation. The waveguide architecture facilitates wavelength-division multiplexing, enabling the readout of multiple sensor elements using a single waveguide. Each element's resonator is tuned to a slightly different wavelength, allowing thousands of resonators to couple to a single waveguide. The implementation of photothermal feedback eliminates the need to actively lock or stabilize a probe laser to the microresonator, thus allowing use of a modulated carrier with sidebands addressing each resonator. This feedback enables greatly increased bandwidth, without sacrificing sensitivity, thereby overcoming the limitations of current bolometer technology, without requiring cryogenic temperatures.

In an embodiment, a bolometer-optical microresonator infrared sensor comprises a frame; at least two legs mechanically supporting an island to the frame, wherein a ridge is patterned into each leg forming a waveguide; a microresonator located on the island comprising a closed loop ridge waveguide; an absorber on the island separated from the microresonator; a waveguide coupler on the island for connecting a waveguide on each leg to the microresonator; a waveguide transition on the frame located at an end of each leg for transmitting light between the waveguide on the leg and a waveguide supported by a substrate; and an edge coupler at an end of the substrate-supported waveguide. In an embodiment, the sensor further comprises at least one non-waveguide support leg mechanically attached to the island and the frame. In an embodiment, the frame is silicon. In an embodiment, each leg is silicon nitride. In an embodiment, the microresonator is a ring. In an embodiment, the microresonator has a quality factor Q greater than 10⁶. In an embodiment, the absorber is a grid of metallic crosses. In an embodiment, the ridge patterned into each leg has a width w less than 4 μm. In an embodiment, each leg has a length L greater than 100 μm. In an embodiment, the sensor further comprises a second island mechanically supported by the frame with legs; a second microresonator on the second island; a second absorber on the second island; a second waveguide coupler on the second island; and a second edge coupler at a second end of the substrate-supported waveguide; wherein the second absorber is shielded by a radiation shield.

The frame (201) provides structural support for the sensor (200), serving as a mounting point for the legs (203) and other components. It can be implemented using a silicon substrate, providing a robust and stable platform. The frame enhances the mechanical stability and durability of the sensor. The frame may be fabricated from various materials such as silicon, glass, or ceramic, depending on the specific application requirements.

The legs (203) mechanically support the island (204) relative to the frame (201) and provide thermal isolation for the island. They are implemented using micromachined silicon nitride structures with integrated waveguides. This arrangement allows both mechanical support and optical signal routing to and from the island. The legs minimize thermal conduction between the island and the frame, increasing temperature sensitivity by reducing thermal losses. The waveguides integrated into the legs efficiently transmit light to and from the microresonator (205). The number and geometry of the legs can be varied to optimize thermal isolation and mechanical stability. The legs may also incorporate additional features, such as stress-relieving structures or integrated heaters, to enhance sensor performance and stability.

The microresonator (205), located on the island (204), enhances light-matter interaction and provides a sensitive transduction mechanism. It is implemented as a closed-loop ridge waveguide, typically a ring resonator, fabricated from silicon nitride. The microresonator supports whispering gallery modes, enhancing light intensity within the ring and increasing sensitivity to changes in temperature or absorbed power. The high quality factor of the microresonator translates directly to enhanced sensitivity. The shape, size, and material of the microresonator can be varied to optimize its optical properties and achieve desired resonance frequencies.

The absorber (206), also located on the island (204), captures incident infrared radiation. It can be implemented using various materials or structures, such as a thin film of carbon nanotubes, a frequency-selective surface, or a metallic layer. The absorber converts incident IR radiation into heat, raising the temperature of the island and, consequently, the microresonator. The absorber's material and geometry can be tailored to optimize absorption at specific wavelengths or bandwidths.

The waveguide coupler (207) on the island (204) facilitates efficient coupling of light between the waveguides on the legs (203) and the microresonator (205). It can be implemented as a silicon nitride ridge waveguide, carefully positioned near the microresonator to achieve efficient energy transfer. The waveguide coupler maximizes the amount of light coupled into and out of the microresonator, enhancing sensitivity and reducing signal loss. The coupler may be implemented using various coupling schemes, such as evanescent coupling or directional coupling, and its design can be optimized to achieve desired coupling strength and bandwidth.

The waveguide transition (208), located on the frame (201) at the ends of the legs (203), facilitates efficient transfer of optical signals between the freestanding waveguides on the legs and the substrate-supported waveguides. It can be implemented as a tapered waveguide structure. This design minimizes signal loss during the transition between different waveguide types, enhancing overall sensor performance. The geometry of the transition may be optimized to minimize reflections and scattering, improving transmission efficiency.

The substrate-supported waveguide (209) guides light signals on the frame, providing a stable platform for optical routing and integration with other components. It can be implemented using conventional waveguide technology on a substrate. This configuration simplifies integration with standard optical components, facilitating system-level design. The waveguide may be fabricated from various materials, such as silicon nitride or silicon-on-insulator, and may be designed for single-mode or multimode operation.

The edge coupler (213, 215) provides a means for coupling light into and out of the substrate-supported waveguides (209) at the edges of the sensor chip. These edge couplers enable efficient coupling of light to and from external sources, such as optical fibers, simplifying integration with larger optical systems. The design of the edge couplers may be optimized for specific fiber types or other optical components, and may incorporate features such as gratings or lenses to enhance coupling efficiency.

The bolometer-optical microresonator infrared sensor achieves significant technical advantages through the integration of these elements. The all-dielectric support legs, combined with the elimination of metallic readouts, provide superior thermal isolation, leading to enhanced sensitivity. The high-quality-factor microresonator, combined with optimized waveguide coupling, provides rapid detection and efficient signal transduction. The use of optical readout and waveguide architecture facilitates wavelength-division multiplexing, enabling simultaneous measurements from multiple sensor elements. The inherent photothermal feedback mechanism associated with strongly coupled resonators eliminates the need for complex active stabilization schemes, enhancing bandwidth while simplifying system design.

Non-waveguide support legs (202) provide additional mechanical support for the island (204) and enhance stability. These legs may be implemented as simple beams or trusses fabricated from silicon nitride. The additional mechanical support reduces stress on the waveguiding legs (203) minimizing bending losses in the waveguides and, thus, optimizing signal transmission. The non-waveguide support legs can be designed with varying geometries and cross-sections to achieve desired mechanical properties.

The frame (201) may be fabricated from silicon, providing a robust and readily available substrate material. Silicon is compatible with standard microfabrication processes, simplifying device fabrication.

The legs (202, 203) may be fabricated from silicon nitride, a material with excellent mechanical and optical properties, as well as low thermal conductivity, thus minimizing thermal losses and improving sensitivity. Silicon nitride is also compatible with standard microfabrication processes.

The microresonator (205) may be ring-shaped, a geometry that supports whispering gallery modes and enhances light-matter interaction. Ring resonators are commonly used in optical sensing applications due to their high quality factors and case of fabrication.

A quality factor Q greater than 10⁶ ensures sharp resonance lines, further enhancing sensitivity to small changes in temperature or absorbed power. High-Q resonators are essential for achieving optimal sensor performance.

The absorber (206) may comprise a grid of metallic crosses. This specific implementation of a frequency selective surface offers efficient absorption of infrared radiation while allowing for simple fabrication using standard lithographic techniques. The dimensions of the crosses can be tailored to optimize absorption at specific wavelengths.

A ridge width (210), e.g., of less than 4 μm, for the waveguides on the legs confines the optical mode, reducing propagation losses and maintaining high quality factor for the waveguide. This dimension is compatible with standard lithographic fabrication processes.

A leg length (212), e.g., greater than 100 μm, enhances thermal isolation by increasing the thermal resistance of the legs. Longer legs result in greater temperature differences between the island and the frame for a given incident power, enhancing sensitivity.

The inclusion of a second island (218), microresonator (205), absorber (206), waveguide coupler (207), and edge coupler (214, 216) forms a dual-sensor configuration in which the second sensor acts as a reference or dark pixel. The radiation shield (219) prevents incident IR radiation from reaching the dark pixel's absorber. This arrangement improves the sensor's stability by allowing compensation for ambient temperature fluctuations or other environmental factors, which affect both sensors equally.

The use of silicon nitride for the legs enhances thermal isolation and improves sensitivity. Silicon for the frame offers robustness and compatibility with standard microfabrication methods. The ring-shaped microresonator and high quality factor ensure strong light-matter interaction and enhance sensitivity. The grid of metallic crosses provide efficient IR absorption, and the sub-4-μm ridge width minimizes waveguide losses. Legs longer than 100 μm further improve thermal isolation. The dual-sensor arrangement compensates for environmental factors. The integration of these features results in a high-performance sensor with enhanced sensitivity, speed, and stability, suitable for a wide range of applications.

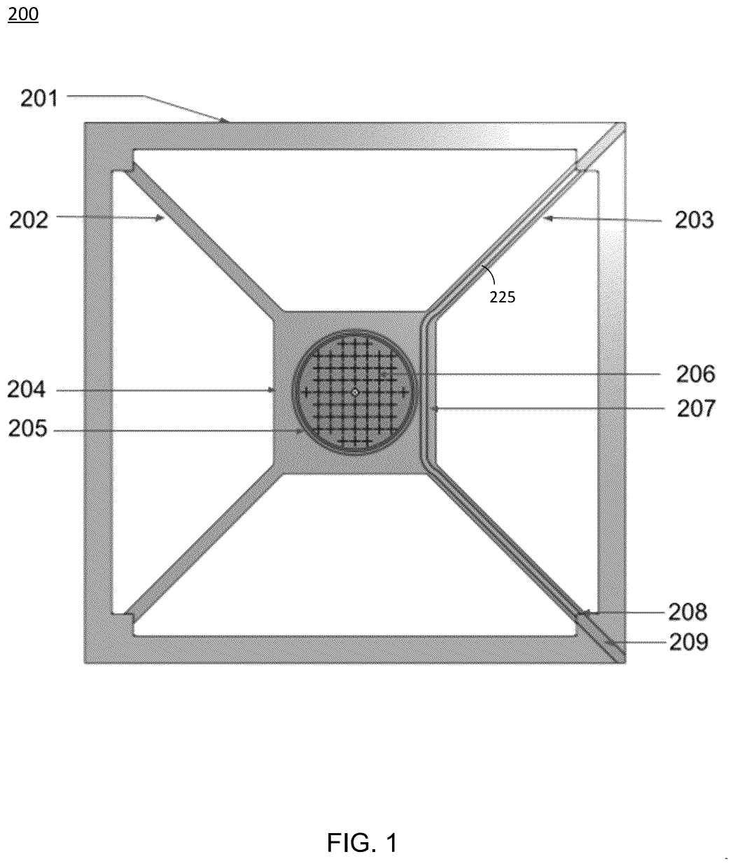

FIG. 1 provides a schematic illustration of a single-pixel bolometer-optical microresonator infrared sensor (200). The sensor comprises a frame (201), support legs (202, 203), an island (204), a microresonator (205), an absorber (206), a waveguide coupler (207), waveguide transitions (208), and substrate-supported waveguides (209). The frame (201) provides mechanical support for the sensor. The legs (202, 203) connect the frame to the island (204), a smaller structure suspended in the center of the frame. The legs provide mechanical support for the island and ensure thermal isolation from the frame. Two of the legs also serve as waveguides, guiding light to and from the island. These waveguiding legs (203) incorporate a ridge structure that defines the waveguide. The non-waveguiding legs (202) are support structures. The microresonator (205), shown as a ring structure on the island, enhances light-matter interaction and provides sensitive transduction. The absorber (206), a patterned structure on the island, captures incident infrared radiation. The waveguide coupler (207), located on the island near the microresonator, couples light between the waveguides on the legs and the microresonator. This arrangement allows light from an external source to be coupled into and out of the microresonator. The waveguide transitions (208), located where the legs meet the frame, facilitate efficient transfer of optical signals between the freestanding waveguides on the legs and the waveguides supported by the substrate. The substrate-supported waveguides (209) guide light signals on the frame to and from the edge couplers. While not shown in FIG. 1, edge couplers are located at the ends of the substrate-supported waveguides for coupling light into and out of the sensor chip. The materials used for the sensor components in this embodiment include silicon for the frame and silicon nitride for the legs, island, microresonator, and waveguide coupler. The absorber may be implemented using a variety of materials or structures, such as carbon nanotubes, frequency selective surfaces, or a thin metallic film. The dimensions of the sensor components, including the frame size, leg length and width, island size, microresonator dimensions, and absorber size, can be varied to optimize performance for different wavelength ranges. The sensor may incorporate additional features, such as integrated heaters or on-chip filters, to enhance performance or stability. The sensor can be packaged in a vacuum or controlled environment to minimize thermal noise and drift. The sensor architecture is scalable, and multiple sensor elements can be integrated onto a single chip to create sensor arrays. The use of optical readout, rather than electrical connections to the island, minimizes thermal losses and improves sensitivity. The waveguide architecture enables wavelength-division multiplexing, allowing for the readout of multiple sensor elements using a single waveguide.

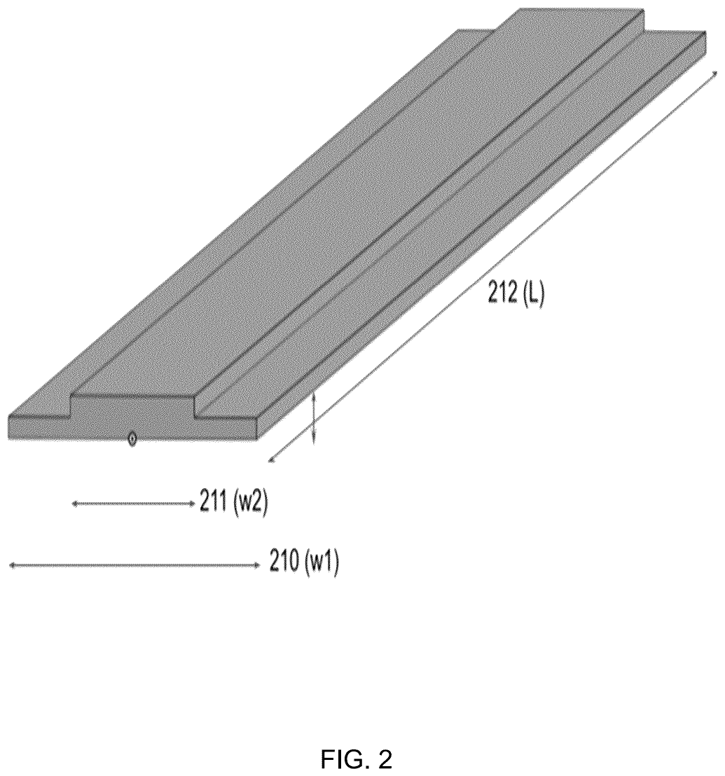

FIG. 2 provides a detailed view of a freestanding waveguide support leg (203), highlighting its key dimensions and structural features. The leg comprises a silicon nitride base structure with a patterned ridge forming the waveguide. The waveguide leg width (210) is the overall width of the leg, and the ridge width (211) is the width of the raised ridge that forms the waveguide core. The waveguide leg length (212) extends along the leg's primary axis. These dimensions are design parameters that influence the leg's thermal, mechanical, and optical properties. The waveguide leg width (210) affects thermal conductance and mechanical strength. Narrower legs reduce thermal conduction, enhancing thermal isolation of the island (204) from the frame (201), which improves sensitivity, but narrow legs also compromise mechanical robustness. Wider legs, on the other hand, enhance mechanical strength and stability but can increase thermal losses, decreasing sensitivity. The ridge width (211) determines the waveguide's mode profile, propagation loss, and coupling efficiency to the microresonator (205). Narrower ridge widths typically improve light confinement, reduce propagation loss, and enhance coupling efficiency, while wider ridges may support multimode propagation, potentially degrading sensor performance. The waveguide leg length (212) influences thermal isolation, with longer legs increasing thermal resistance and maximizing temperature changes on the island due to absorbed IR radiation. However, excessively long legs may compromise mechanical stability, increasing susceptibility to vibrations or other mechanical disturbances. The choice of leg dimensions involves a trade-off between thermal isolation, mechanical stability, and optical performance. Typical waveguide leg widths range from 1 μm to 10 μm, ridge widths from 0.5 μm to 2 μm, and leg lengths from 50 μm to 1 mm. Specific dimensions are chosen based on the target wavelength range, desired sensor bandwidth, and mechanical constraints. The leg structure may be further optimized by incorporating stress-relieving features or other geometric modifications to enhance mechanical robustness. The waveguide may be designed for single-mode or multimode operation depending on the application requirements. The leg material, typically silicon nitride, is chosen for its low thermal conductivity, high mechanical strength, and excellent optical properties at the operating wavelength (near 1.55 μm). Alternative materials, including silicon dioxide or certain polymers, may be used if their properties meet the thermal, mechanical, and optical design criteria. The leg geometry can be varied to include tapers, curves, or other shapes to optimize thermal or mechanical properties. The ridge profile may be rectangular, trapezoidal, or other shapes, influencing waveguide performance. The number of support legs can be adjusted to accommodate different sensor designs and pixel layouts. The leg structure can be further enhanced by integrating electrical interconnects or other functional elements, potentially enabling on-chip heating, temperature sensing, or other functionalities.

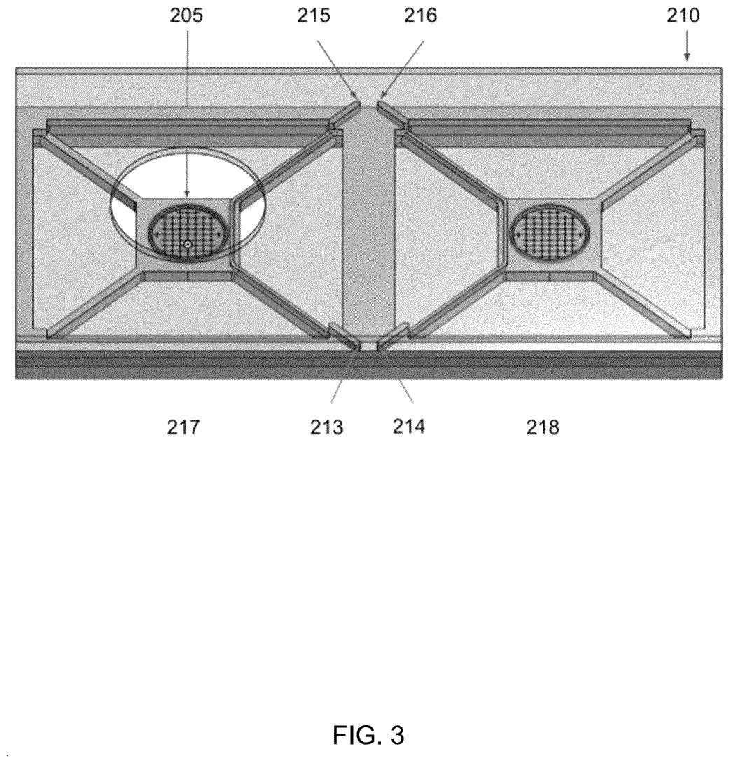

FIG. 3 illustrates a dual-pixel configuration of the bolometer-optical microresonator infrared sensor, incorporating bright (217) and dark (218) pixels for enhanced performance and stability. Each pixel includes an island (204), a microresonator (205), an absorber (206), a waveguide coupler (207), and associated waveguides and edge couplers. The bright pixel (217) is exposed to the incident infrared radiation, while the dark pixel (218) is shielded. This dual-pixel arrangement enables differential measurements, compensating for ambient temperature fluctuations and enhancing accuracy. In FIG. 3, the bright and dark pixels are located on a common frame (201) and share the substrate-supported waveguides (209) and edge couplers. The bright pixel waveguide input edge coupler (213) and the dark pixel waveguide input edge coupler (214) are positioned to receive light from separate input waveguides, allowing independent control over the optical signals delivered to each pixel. Similarly, the bright pixel waveguide output edge coupler (215) and the dark pixel waveguide output edge coupler (216) direct light from the respective output waveguides to separate photodiodes for differential measurement. The waveguides on the legs (203) connect the microresonators to the edge couplers, ensuring efficient signal routing. The absorber (206) on each pixel captures incident radiation, and the microresonator (205) transduces the resulting temperature change into a shift in resonance frequency. The waveguide coupler (207) facilitates efficient light coupling between the waveguides and the microresonators. While not explicitly shown in FIG. 3, a radiation shield (219) typically covers the dark pixel, preventing incident radiation from reaching its absorber. This shield ensures that the dark pixel's response reflects only ambient conditions, enabling accurate temperature compensation. The dimensions and materials of the bright and dark pixels are typically identical to maximize common-mode noise rejection. The separation between the pixels on the chip is chosen to minimize thermal crosstalk while allowing for compact device design. The waveguides and edge couplers are designed for efficient single-mode operation at the operating wavelength. The dual-pixel configuration can be extended to larger arrays, with multiple bright and dark pixels arranged in various patterns, enabling high-resolution thermal imaging. The sensor chip may incorporate additional features, such as integrated heaters or temperature sensors, to further enhance performance and stability. The substrate-supported waveguides can be configured for various readout schemes, including wavelength-division multiplexing, allowing for simultaneous readout of multiple pixels using a single waveguide.

The bolometer-optical microresonator infrared sensor (200) is a novel device designed for high-speed, high-sensitivity detection of infrared and far-infrared light, incorporating a micromachined thermal isolation structure, an optical microresonator for transduction, and integrated waveguides for optical readout. The sensor leverages the photothermal effect, where absorbed infrared radiation causes a temperature change that modifies the optical properties of the microresonator. This change is detected as a variation in the intensity of light transmitted through the microresonator. The sensor can include various elements such as a frame (201), legs (202, 203) for supporting an island (204) on which are located a microresonator (205), an absorber (206), and a waveguide coupler (207). Additional elements include waveguide transitions (208) for efficient signal routing, substrate-supported waveguides (209), and edge couplers (213-216) for optical input and output. The sensor's performance is significantly enhanced by the high quality factor (Q) of the microresonator, amplifying small changes in temperature or absorbed power. The thermal isolation of the island from the surrounding frame, achieved through the low thermal conductivity legs, maximizes the temperature change induced by incident IR radiation, and thus enhances the bolometer's sensitivity. The integration of waveguides into the support legs enables efficient optical readout, eliminating the need for electrical interconnects, minimizing thermal losses and enabling further size reduction. The sensor is compatible with standard microfabrication processes, facilitating its integration with other optical and electronic components, allowing it to be readily incorporated into larger systems. The sensor's small size, stemming from micromachining, makes it suitable for a wide range of applications, such as thermal imaging, spectroscopy, and remote sensing. The sensor structure can be tailored to specific wavelength ranges by careful design of the absorber material and geometry and exhibits high sensitivity and rapid response time, enabling high-bandwidth detection. The sensor architecture can be implemented in various configurations, including single-pixel devices and multi-pixel arrays. Single-pixel devices are suited for applications where spatial resolution is not critical, such as point measurements or spectroscopy. Multi-pixel arrays enable imaging or mapping of IR intensity distributions, useful in applications such as thermal cameras or medical diagnostics. The sensor design and operation can be further enhanced through the use of additional components or techniques, including integrated heaters, on-chip filters, and signal processing algorithms, extending versatility and applicability. Active temperature stabilization, achieved using feedback control loops and integrated heaters, improves sensor stability by minimizing drift caused by ambient temperature fluctuations, and wavelength modulation spectroscopy techniques enhance sensitivity and selectivity by reducing background noise. Dual-sensor configurations, incorporating bright and dark pixels, enable temperature compensation and common-mode noise rejection, leading to higher accuracy measurements. The sensor can be packaged in vacuum or other controlled environment to minimize thermal noise and improve long-term stability. The sensor's small size and low power consumption enable portable and handheld applications, while the high sensitivity and speed facilitate applications such as free-space optical communications or high-speed thermal imaging.

The frame (201) of the bolometer-optical microresonator infrared sensor (200) provides mechanical support and acts as a stable platform for the sensor components, including the legs (202, 203), substrate-supported waveguides (209), and edge couplers (213-216). The frame ensures structural integrity and stability of the sensor assembly. It serves as an anchor point for the legs, which mechanically support the thermally isolated island (204). The frame also provides a base for the substrate-supported waveguides and edge couplers, which route optical signals to and from the sensor. The frame material should exhibit high mechanical strength and stiffness to minimize and resist deformation or displacement due to external stresses or vibrations. The frame can be fabricated from silicon, a material known for its excellent mechanical properties, compatibility with standard microfabrication processes, and cost-effectiveness. Alternative materials, including glass, ceramic, or various polymers, can be used depending on the specific application requirements, such as thermal stability, transparency, or flexibility. The frame's dimensions are typically chosen to accommodate the sensor elements, waveguides, and edge couplers while minimizing the overall device footprint. Frame sizes can range from hundreds of micrometers to several millimeters, specifically from 500 μm to 2 mm, and more specifically approximately 1 mm. For single-pixel sensors, smaller frames may suffice. For sensor arrays, larger frames are needed to accommodate multiple pixels. The frame geometry is typically square or rectangular, providing a convenient shape for chip fabrication and packaging. Alternative shapes, such as circular, elliptical, or other polygonal geometries, can be employed depending on design constraints or integration requirements. The frame thickness influences mechanical stability, with thicker frames generally offering greater robustness. Typical frame thicknesses range from 100 μm to 500 μm, specifically from 200 μm to 400 μm, and more specifically approximately 250 μm, chosen based on the desired level of mechanical stability and compatibility with standard wafer thicknesses. The frame may include additional features such as through-holes or mounting points for integration with other components or packaging structures. The surface of the frame can be treated or coated to improve adhesion, reduce reflections, or enhance other properties. For applications requiring thermal management, the frame can incorporate integrated heaters or coolers for temperature stabilization. The frame may also include electrical interconnects or other circuitry for on-chip signal processing or control.

The non-waveguide support legs (202) maintain the mechanical stability and thermal isolation of the bolometer-optical microresonator infrared sensor (200). These legs provide additional mechanical support for the island (204), supplementing the support provided by the freestanding waveguide legs (203). This added support reduces stress and strain on the waveguiding legs, minimizing bending losses in the integrated waveguides and improving optical transmission efficiency. The non-waveguide support legs also contribute to thermal isolation of the island from the frame (201). Their low thermal conductivity minimizes heat transfer between the island and the frame, maximizing the temperature change on the island caused by absorbed IR radiation and therefore enhancing sensor sensitivity. The non-waveguide support legs are typically fabricated from silicon nitride, a material chosen for its combination of high mechanical strength, low thermal conductivity, and compatibility with standard microfabrication techniques. Alternative materials with suitable mechanical and thermal properties, such as silicon dioxide, certain polymers (e.g., epoxy-based or crosslinked polymer such as SU-8), or other low-thermal-conductivity dielectrics, may be employed. The number of non-waveguide support legs used can vary depending on the specific sensor design, island size, and desired level of mechanical support. Typical designs incorporate one, two, four, or more legs, strategically placed around the island to distribute stress and maintain balance. The legs are anchored to both the island and the frame, ensuring a stable mechanical connection. The geometry of the legs influences their mechanical and thermal performance. Straight legs offer simplicity in design and fabrication. Tapered or curved legs may be employed to optimize stress distribution or improve mechanical robustness. The cross-sectional shape of the legs can be rectangular, trapezoidal, circular, or other shapes depending on the desired mechanical properties and fabrication constraints. The dimensions of the legs, including their length and width, influence both thermal isolation and mechanical stability. Longer legs reduce thermal conductance, improving thermal isolation but potentially increasing susceptibility to mechanical vibrations. Shorter legs provide better mechanical stability but may compromise thermal isolation. Wider legs enhance mechanical robustness but can increase thermal conductance, reducing sensitivity. Narrower legs reduce thermal losses but may be more prone to mechanical failure. The optimal dimensions of the non-waveguide legs balance thermal and mechanical considerations and are typically determined through simulations or experimental testing. Leg lengths may range from tens of micrometers to several millimeters, specifically from 50 μm to 500 μm, and more specifically approximately 200 μm, while leg widths may range from 1 μm to 10 μm, specifically from 2 μm to 5 μm, and more specifically approximately 3 μm. The non-waveguide support legs can incorporate additional features, such as etched slots or grooves, to further reduce thermal conductance. The leg surfaces may be treated or coated to enhance adhesion, reduce friction, or improve other properties.

The freestanding waveguide support legs (203) are components of the bolometer-optical microresonator infrared sensor (200), providing both mechanical support for the sensor's island (204) and a low-loss path for optical signals traveling to and from the microresonator (205). The legs can be fabricated from silicon nitride, a material possessing excellent mechanical properties, low thermal conductivity, and good optical transparency at the sensor's operating wavelength (e.g., near 1.55 μm). These properties are used for achieving high sensitivity, minimizing thermal losses, and ensuring efficient light transmission. Each leg can incorporate a patterned ridge that forms a waveguide. This integrated design minimizes device size and simplifies fabrication, eliminating the need for separate waveguide structures, allowing dense integration of multiple sensor elements. The legs mechanically connect the island to the frame (201), creating a freestanding structure that enhances thermal isolation. This thermal isolation maximizes temperature changes on the island caused by absorbed IR radiation, thereby increasing the sensor's sensitivity. The waveguides formed by the patterned ridges within the legs efficiently guide light to and from the microresonator, minimizing transmission losses and ensuring high optical throughput. The number of freestanding waveguide legs can be varied depending on the specific sensor design and the desired level of mechanical support and redundancy. A typical configuration uses two legs, one for input and one for output, while other embodiments might incorporate four or more legs for enhanced stability or redundancy. The legs are typically straight for simplicity of design and fabrication, but alternative geometries, including curved, tapered, or branched structures can be employed to optimize thermal or mechanical performance, or to accommodate specific routing requirements. The length and width of the legs influence both thermal and mechanical properties. Longer legs enhance thermal isolation but might make the sensor more susceptible to mechanical vibrations. Shorter legs improve mechanical robustness but can increase thermal losses, thus reducing sensitivity. Wider legs enhance mechanical strength but can also increase thermal conductance, negatively affecting sensitivity. Narrower legs minimize thermal conduction, but may be more fragile and prone to mechanical failure. Typical leg lengths range from 50 μm to 1 mm, specifically from 100 μm to 500 μm, and more specifically approximately 250 μm. Typical leg widths range from 1 μm to 10 μm, specifically from 2 μm to 5 μm, and more specifically approximately 3 μm. The ridge width within the leg determines the waveguide's optical properties. Narrower ridge widths enhance light confinement, reducing propagation losses, but wider ridges provide better tolerance to fabrication variations. The ridge height influences the waveguide's effective refractive index and therefore its light-guiding capabilities. Typical ridge widths range from 0.5 μm to 2 μm, specifically from 0.75 μm to 1.5 μm, and more specifically approximately 1 μm. The legs may incorporate additional features, including etched slots or grooves, to further reduce thermal conductance and improve thermal isolation. Surface treatments or coatings can enhance adhesion, reduce friction, or protect the legs from environmental factors. Electrical interconnects or other functional elements may be integrated into the leg structure to provide on-chip heating, temperature sensing, or active control capabilities.

The island (204) in the bolometer-optical microresonator infrared sensor (200) is a freestanding structure that houses sensing elements, including the microresonator (205), the absorber (206), and the waveguide coupler (207). It provides a platform for these elements and ensures their thermal isolation from the surrounding frame (201). The island is mechanically supported by the legs (202, 203), which connect it to the frame. These legs minimize thermal conduction, maximizing the temperature change on the island due to absorbed IR radiation. The island material should exhibit low thermal conductivity to enhance thermal isolation and a high refractive index if the waveguides are integrated into the island material. It is typically fabricated from silicon nitride, a material with excellent thermal and mechanical properties and good optical transparency at the sensor's operating wavelength (e.g., near 1.55 μm). Alternative materials, such as silicon dioxide, certain polymers (e.g., SU-8), or other low-thermal-conductivity dielectrics may be used, provided their properties meet the thermal and mechanical design requirements. The island's size and shape are design parameters that influence its thermal response time and its ability to accommodate the microresonator, absorber, and waveguide coupler. Smaller islands generally exhibit faster thermal response times, enabling detection of more rapid changes in IR intensity. Larger islands accommodate larger absorbers, potentially increasing sensitivity, but at the cost of slower thermal response. The island's size is typically chosen to be on the order of a few wavelengths of the target infrared radiation. Island sizes can range from a few micrometers to hundreds of micrometers, specifically from 10 μm to 200 μm, and more specifically approximately 50 μm. The island shape is usually square or rectangular to simplify fabrication and integration with other sensor elements. However, alternative shapes, including circular, elliptical, or other geometrics, may be used to optimize thermal characteristics or accommodate specific absorber or microresonator designs. The island thickness affects its thermal mass and mechanical properties. Thinner islands offer faster thermal response but may be more susceptible to mechanical deformation. Thicker islands enhance mechanical robustness but increase thermal mass, potentially reducing sensitivity and response speed. Typical island thicknesses range from 50 nm to 500 nm, specifically from 100 nm to 250 nm, and more specifically approximately 150 nm. The island may be designed to incorporate additional features, such as integrated heaters or temperature sensors for thermal control and calibration, and its surface can be treated or coated to improve adhesion, reflectivity, or other properties relevant to sensor performance. The island can also be segmented into multiple thermally isolated regions, each supporting its own microresonator and absorber, allowing for the creation of multi-pixel sensor arrays.

The microresonator (205) is a component of the bolometer-optical microresonator infrared sensor (200), serving as the transducer element that converts temperature changes on the island (204) into detectable shifts in light intensity. The microresonator can be implemented as a closed-loop ridge waveguide, typically a ring resonator, fabricated on the island using a high-refractive-index material. This design confines light within a small volume, enhancing light-matter interaction and enabling sensitive detection of changes in temperature or absorbed power. The microresonator supports whispering gallery modes, characterized by resonant circulating light trapped within the closed-loop waveguide by total internal reflection. This resonant enhancement amplifies the sensor's response to small perturbations, such as temperature changes induced by absorbed IR radiation. The microresonator material should possess several key properties. A high refractive index enables strong light confinement within the waveguide, maximizing light-matter interaction. Low optical absorption at the sensor's operating wavelength (near 1.55 μm) minimizes signal loss and maintains the resonator's quality factor. A significant thermo-optic coefficient ensures that changes in temperature produce measurable shifts in the microresonator's resonance frequency. Silicon nitride is a useful material due to its high refractive index, low optical loss at 1.55 μm, and moderate thermo-optic coefficient. Alternative materials, such as silicon, tantalum pentoxide (Ta₂O₅), or other high-index transparent materials can be employed. Silicon offers an even higher refractive index and compatibility with CMOS processes. Tantalum pentoxide exhibits a larger thermo-optic coefficient, increasing sensitivity. The choice of material is dictated by the specific application requirements, operating wavelength range, and desired sensitivity. The microresonator dimensions, including ring radius and waveguide width, determine its optical properties, including resonance frequency, free spectral range, and quality factor (Q). Smaller resonators typically exhibit higher quality factors, enhancing sensitivity but reducing mode volume, which can decrease coupling efficiency to the waveguides. Larger resonators may have lower Q's but provide increased mode volume. Ring radii can range from 5 μm to 500 μm, specifically from 10 μm to 100 μm, and more specifically approximately 50 μm. Waveguide widths typically range from 0.5 μm to 2 μm, specifically from 0.75 μm to 1.5 μm, and more specifically approximately 1 μm. The microresonator geometry is typically a ring or racetrack shape for supporting whispering gallery modes, but alternative designs, such as disk resonators, photonic crystal cavities, or other resonator geometries can be employed to tailor the optical properties to the specific application. The microresonator's quality factor Q, a measure of its optical loss, is a crucial performance parameter. Higher Q values translate to sharper resonance lines, increasing sensitivity to small shifts in resonance frequency and thus enhancing the sensor's overall sensitivity. Quality factors can range from 10³ to 10⁹, specifically from 10⁶ to 10⁸, and more specifically approximately 5×10⁷. The microresonator can incorporate additional features, including integrated heaters or temperature sensors, to further improve performance or enable active control functionalities. Its surface may be treated or coated to modify its optical properties, including reflectivity or absorption, or to protect it from environmental factors.

The absorber (206) captures incident infrared radiation and converting it into heat, thereby initiating the sensor's photothermal transduction process. The absorber is located on the island (204), physically separated from the microresonator (205) to avoid perturbing its optical properties. The absorber material and geometry are carefully chosen to maximize absorption efficiency at the target wavelength or range of wavelengths. The absorber material should exhibit high absorption in the target wavelength range and low reflectivity to minimize losses. The material's thermal properties, including thermal conductivity and heat capacity, influence the sensor's speed and sensitivity. Suitable absorber materials include metals such as gold, aluminum, or titanium, which offer high absorption across a broad range of IR wavelengths. Other materials with strong IR absorption, including carbon nanotubes, graphene, or other nanomaterials, are also potential candidates. For applications requiring wavelength-selective absorption, frequency selective surfaces (FSS), comprising periodic arrays of metallic elements, metamaterials, or other resonant structures can be employed. These structures exhibit strong absorption at specific wavelengths or narrow bandwidths determined by their geometry and material properties. The absorber geometry is a design parameter that influences absorption efficiency, spatial resolution, and thermal response time. Larger absorbers generally capture more incident radiation, increasing sensitivity, but also increase thermal mass which can slow down the sensor's response. Smaller absorbers provide faster response times but capture less radiation, decreasing sensitivity. Simple geometries, such as rectangles or squares, simplify fabrication, while more complex shapes, including fractal patterns or other resonant structures, can enhance absorption at specific wavelengths. The absorber dimensions typically range from a few micrometers to the full size of the island, specifically from 10 μm to 100 μm, and more specifically approximately 50 μm. The absorber thickness influences its absorption efficiency, with thicker absorbers generally absorbing more radiation. However, thicker absorbers also increase thermal mass, which may negatively impact response time. Absorber thicknesses can range from a few nanometers to several micrometers, specifically from 10 nm to 1 μm, and more specifically approximately 100 nm. The absorber may incorporate additional features or layers to optimize performance. Anti-reflection coatings minimize surface reflections and enhance absorption efficiency. A thermally conductive layer between the absorber and the island improves heat transfer, maximizing the sensor's response to absorbed radiation. The absorber can be integrated with other components, such as filters or polarizers, to enhance wavelength selectivity or polarization sensitivity, expanding the sensor's applicability to different measurement scenarios.

The waveguide coupler (207) provides efficient transfer of light between the waveguides on the legs (203) and the microresonator (205). The waveguide coupler is typically fabricated on the island (204) using the same material as the microresonator, ensuring low-loss transmission and efficient coupling. Silicon nitride, with its high refractive index and low optical loss at the sensor's operating wavelength (e.g., near 1.55 μm) is a useful material. Other materials with suitable optical properties, including silicon, silicon dioxide, or certain polymers, can be used depending on the specific application requirements and fabrication process constraints. The waveguide coupler's physical structure is designed to optimize coupling efficiency and minimize signal losses. The coupler is situated in close proximity to the microresonator to enable evanescent coupling, a mechanism by which light can be transferred between adjacent waveguides without direct physical contact. The gap between the waveguide coupler and the microresonator influences the coupling strength and bandwidth. Smaller gaps typically result in stronger coupling but may also increase back reflections or introduce unwanted interference effects. Larger gaps weaken the coupling, potentially reducing sensitivity. The optimal gap distance balances coupling efficiency with other performance considerations and is typically determined through simulations or experimental testing. Gap distances may range from tens of nanometers to several micrometers, specifically from 100 nm to 1 μm, and more specifically approximately 500 nm. The geometry of the waveguide coupler can vary depending on the desired coupling scheme and the microresonator design. Straight waveguides provide simple coupling for ring or racetrack resonators, while curved or bent waveguides enable coupling to resonators with more complex shapes. The waveguide coupler's dimensions, including its width and height, determine its mode profile, influencing coupling efficiency and bandwidth. Typical waveguide widths range from 0.5 μm to 2 μm, specifically from 0.75 μm to 1.5 μm, and more specifically approximately 1 μm, chosen to achieve single-mode operation and match the dimensions of the waveguides on the legs, maximizing coupling efficiency. The waveguide coupler can be implemented using various coupling schemes. Evanescent coupling, relying on the overlap of optical fields between the waveguide and the microresonator, offers high efficiency and is readily implemented using standard lithographic techniques. Directional coupling, employing two or more closely spaced waveguides, allows precise control over the coupling strength and can be used to create wavelength-selective couplers. Grating couplers, using periodic structures to diffract light into or out of the waveguide, provide another coupling option. The choice of coupling scheme depends on factors such as desired coupling efficiency, bandwidth, and fabrication complexity. The waveguide coupler may incorporate additional features to enhance performance or functionality. Integrated heaters or temperature sensors enable thermal control or calibration of the coupler's properties. Optical filters or polarizers can enhance wavelength selectivity or polarization sensitivity, and the coupler can be designed to be tunable, allowing dynamic control over the coupling strength.

The waveguide transition (208) provides efficient transfer of optical signals between the freestanding waveguides on the legs (203) and the substrate-supported waveguides (209). The waveguide transition is typically located on the frame (201) at the point where the legs meet the frame. It minimizes signal losses during the transition between the freestanding waveguides, which can be air-clad or have a low-index cladding, and the substrate-supported waveguides, which are typically embedded in a higher-index material. The waveguide transition can match the mode field profiles of the two waveguide types, minimizing reflections and scattering losses at the interface. The transition geometry typically involves a gradual change in waveguide dimensions, such as a taper, to smoothly connect the two waveguide sections. A linear taper provides a simple and effective transition for many applications. More complex taper profiles, such as exponential or other functional forms, can be used to optimize performance for specific waveguide geometries or refractive index contrasts. The waveguide transition is typically fabricated using the same material as the substrate-supported waveguides to minimize material discontinuities and reduce reflections. Silicon nitride is a preferred material due to its low optical loss at the operating wavelength (e.g., near 1.55 μm) and compatibility with the freestanding waveguides on the legs. Other materials with suitable optical properties, such as silicon or certain polymers, can be employed. The dimensions of the waveguide transition are chosen to ensure efficient mode matching and minimize transmission losses. The length of the taper influences the transition's bandwidth and its sensitivity to fabrication variations. Longer tapers generally provide smoother transitions and broader bandwidth but may occupy more space on the chip. Shorter tapers can be more compact but might introduce higher losses or be more susceptible to fabrication imperfections. Taper lengths can range from a few micrometers to hundreds of micrometers, specifically from 10 μm to 100 μm, and more specifically approximately 50 μm. The width of the waveguide transition varies along its length to match the dimensions of the freestanding and substrate-supported waveguides. The initial width, at the interface with the freestanding waveguide, is chosen to match the waveguide's mode field diameter. The final width matches the substrate-supported waveguide's dimensions. The waveguide transition may incorporate additional features to enhance performance or functionality. For example, a grating structure may be added to improve coupling efficiency or provide wavelength selectivity, and an integrated heater or temperature sensor allows thermal control of the transition's optical properties. The waveguide transition can be designed to be polarization-insensitive, ensuring efficient transmission regardless of the input light's polarization state.

The substrate-supported waveguides (209) provide a low-loss path for routing optical signals on the sensor chip. These waveguides are fabricated on the frame (201) using a high-refractive-index material deposited onto a lower-index substrate. This configuration creates a waveguide structure that confines and guides light along the waveguide path. The waveguides connect the waveguide transitions (208) at the ends of the legs (203) to the edge couplers (213-216), which facilitate coupling of light to and from external optical fibers or other components. The waveguides may also connect to other on-chip optical components, such as filters, splitters, or modulators, allowing implementation of more complex optical functionalities. The waveguide material should exhibit low optical loss at the sensor's operating wavelength and be compatible with the fabrication process. Silicon nitride, with its high refractive index and low loss at 1.55 μm, is a useful material, ensuring efficient light transmission. Alternative materials, such as silicon, silicon dioxide, or certain polymers, may be employed depending on the application requirements, operating wavelength, and available fabrication processes. The waveguide geometry influences its optical properties, including its mode profile, effective refractive index, and propagation loss. Ridge waveguides, formed by etching or depositing a high-index ridge on a lower-index substrate, are commonly used in silicon nitride or silicon photonics and confine light within the ridge due to total internal reflection. Channel waveguides, created by etching a channel into a higher-index substrate, provide another approach for guiding light and allow for stronger light confinement. The waveguide dimensions, such as width, height, and ridge height (for ridge waveguides) influence their optical properties. Waveguide widths typically range from 0.5 μm to 2 μm, specifically from 0.75 μm to 1.5 μm, and more specifically approximately 1 μm, while waveguide heights typically range from 0.1 μm to 1 μm, specifically from 0.2 μm to 0.5 μm, and more specifically approximately 0.3 μm. These dimensions determine the number of optical modes supported by the waveguide (single-mode or multi-mode operation) and affect propagation losses. The substrate-supported waveguides are typically arranged in a linear or curved path to connect the waveguide transitions at the ends of the legs to the edge couplers. The length of the waveguides influences the overall optical path length and can introduce propagation losses, which should be minimized. The waveguides can be designed to incorporate additional features to enhance functionality or performance. For example, a grating structure etched into the waveguide can act as a filter, selecting specific wavelengths or a splitter, dividing the optical signal into multiple paths. Phase shifters or modulators can be integrated to control the phase or amplitude of the light propagating through the waveguides. The waveguides may be designed for polarization-maintaining or polarization-insensitive operation depending on the application requirements.

The waveguide leg width (210) is a design parameter in the bolometer-optical microresonator infrared sensor (200), influencing both the thermal and mechanical properties of the legs (203). The legs, which mechanically support the island (204) and house the integrated waveguides (225), play a role in the sensor's performance by providing thermal isolation and enabling efficient optical signal routing. The waveguide leg width directly affects the thermal conductance of the legs. Narrower legs, having smaller cross-sectional area, reduce thermal conduction between the island and the frame (201). This enhanced thermal isolation maximizes the temperature change on the island due to absorbed IR radiation, which improves the sensor's sensitivity. However, decreasing leg width also compromises mechanical strength and stability, potentially making the sensor more susceptible to breakage or deformation due to stress or vibrations. Wider legs provide greater mechanical support and robustness but increase thermal conductance, reducing the sensor's sensitivity. Therefore, the choice of waveguide leg width involves a balance between thermal isolation and mechanical stability. The optimal width depends on various factors, including the thermal properties of the leg material, the desired sensor bandwidth, and the mechanical constraints of the sensor design and its packaging. Typical waveguide leg widths range from 1 μm to 10 μm, specifically from 2 μm to 5 μm, and more specifically approximately 3 μm. These dimensions balance thermal isolation with mechanical strength, enabling high sensitivity while maintaining structural integrity. The waveguide leg width can be further optimized by adjusting the leg length (212) and the leg geometry. Longer legs enhance thermal isolation, allowing for wider leg widths without compromising sensitivity excessively. Curved or tapered legs can improve mechanical stability, allowing for narrower leg widths without sacrificing structural integrity. The leg material also influences the choice of waveguide leg width. Materials with lower thermal conductivity, such as silicon nitride or silicon dioxide, allow for wider legs while maintaining good thermal isolation. Materials with higher thermal conductivity, such as silicon, may necessitate narrower legs to achieve comparable thermal performance. The fabrication process limitations also constrain possible waveguide leg widths. Electron beam lithography and dry etching processes can typically define features with sub-micrometer precision. For larger leg widths, less complex and more cost-effective lithography techniques, such as deep-ultraviolet (DUV) lithography or photolithography, may suffice.

The ridge width (211) is a parameter in the design and fabrication of the freestanding waveguide support legs (203) in the bolometer-optical microresonator infrared sensor (200), influencing the optical performance and, therefore, the sensitivity of the sensor. The legs, fabricated from silicon nitride, provide mechanical support for the sensor's island (204) and incorporate a patterned ridge that forms a waveguide (225) for routing light to and from the microresonator (205). The ridge width determines the waveguide's mode profile, which describes the spatial distribution of the light within the waveguide, which in turn affects the waveguide's propagation loss and its coupling efficiency to the microresonator. Smaller ridge widths typically result in tighter confinement of the optical mode, reducing propagation losses and increasing the interaction of the light with the microresonator, which can enhance sensitivity. However, excessively narrow ridge widths increase the waveguide's sensitivity to fabrication imperfections, such as sidewall roughness or variations in ridge width, potentially increasing losses and degrading performance. Wider ridge widths are less sensitive to fabrication variations, improving device yield, but may support multiple optical modes, leading to modal dispersion and reducing the sensor's spectral resolution. Modal dispersion occurs when light travels through the waveguide in multiple spatial modes, each with a slightly different propagation constant. This causes the light pulse to spread out in time, reducing the sensor's bandwidth and its ability to resolve rapid changes in IR intensity. The optimal ridge width balances these competing considerations, minimizing propagation loss while maintaining single-mode operation and tolerance to fabrication variations. Typical ridge widths range from 0.5 μm to 2 μm, specifically from 0.75 μm to 1.5 μm, and more specifically approximately 1 μm. These dimensions are well within the capabilities of standard lithographic fabrication techniques, such as electron beam lithography or deep-ultraviolet (DUV) lithography. The choice of ridge width is influenced by several factors, including the refractive index contrast between the waveguide core (the ridge) and the surrounding cladding material (typically air or a low-index dielectric), as well as the operating wavelength of the light carried by the waveguide. Higher index contrast enables tighter confinement of the optical mode, allowing for smaller ridge widths without sacrificing single-mode operation, which can reduce propagation loss and improve sensitivity. Longer wavelengths require wider waveguides to maintain single-mode operation. The ridge width is typically chosen to ensure single-mode operation at the desired wavelength while minimizing propagation loss and maximizing coupling efficiency to the microresonator. The ridge height also affects waveguide performance by influencing its effective refractive index and mode profile. Taller ridges usually provide stronger light confinement, which may be necessary for certain applications, such as coupling to small microresonators. The ridge profile, which can be rectangular, trapezoidal, or other shapes, further influences the waveguide's optical properties and should be chosen to minimize scattering losses and maintain single-mode operation. The ridge width can be fine-tuned during fabrication through careful control of the lithography and etching process parameters.

The waveguide leg length (212) is a design parameter influencing the performance of the bolometer-optical microresonator infrared sensor (200), specifically impacting thermal isolation, mechanical stability, and overall sensor sensitivity. The legs (203), can be fabricated, e.g., from silicon nitride, provide mechanical support for the sensor's island (204) and incorporate patterned ridges that form waveguides (225) for routing optical signals to and from the microresonator (205). The leg length determines the thermal resistance between the island and the frame (201). Longer legs, having a greater distance between the island and the frame, offer higher thermal resistance, minimizing thermal conduction and maximizing temperature changes on the island due to absorbed IR radiation. This enhanced thermal isolation is for achieving high sensitivity, as it amplifies the sensor's response to small changes in incident power. However, excessively long legs compromise mechanical stability, making the sensor more prone to bending, breakage, or other mechanical failures due to stresses or vibrations. Shorter legs improve mechanical robustness but reduce thermal isolation, thus potentially decreasing sensitivity. Therefore, selecting the appropriate waveguide leg length involves optimizing thermal isolation without compromising mechanical stability. Typical leg lengths range from 50 μm to 1 mm, specifically from 100 μm to 500 μm, and more specifically approximately 250 μm. These lengths balance thermal and mechanical performance, achieving high sensitivity while maintaining structural integrity. The choice of leg length is influenced by several factors. The leg material's thermal conductivity plays a role as well. Materials with lower thermal conductivity, such as silicon nitride or silicon dioxide, allow for shorter legs while maintaining adequate thermal isolation. Materials with higher thermal conductivity, such as silicon, may require longer legs to achieve comparable performance. The leg width (210) also influences the choice of leg length. Narrower legs reduce thermal conductance, so longer leg lengths can be employed for increased thermal isolation without significantly compromising mechanical stability. Wider legs have higher thermal conductance, potentially requiring shorter leg lengths to maintain acceptable thermal performance. The design and packaging of the sensor also influence the choice of leg length. For vacuum-packaged sensors, where mechanical vibrations are less of a concern, longer legs can be used to maximize thermal isolation. For sensors operating in environments subject to vibrations or mechanical shocks, shorter, more robust legs are often necessary. Standard microfabrication processes can typically create freestanding structures with lengths up to several millimeters. However, for very long legs, custom fabrication methods or design modifications can be used to ensure structural integrity and prevent buckling or collapse.

The bright pixel waveguide input edge coupler (213) is a component in the bolometer-optical microresonator infrared sensor (200), enabling efficient coupling of light from an external source, such as a tunable laser (226), into the sensor's integrated waveguide circuitry. The edge coupler is typically located on the frame (201) of the sensor and is precisely aligned with the input waveguide (227), which carries light from the laser. The edge coupler design should maximize coupling efficiency, minimizing losses during the transition from the external waveguide, typically an optical fiber, to the on-chip waveguides (209). Various edge coupler designs can be employed. Grating couplers, based on diffraction of light by a periodic structure, offer broadband operation and case of fabrication. Etched facet couplers, utilizing a precisely angled or cleaved edge of the waveguide, provide high coupling efficiency but are more sensitive to fabrication variations and require precise alignment. Inverse taper couplers, which gradually reduce the waveguide dimensions to match the mode field diameter of the optical fiber, offer efficient coupling and reduced back reflections, while adiabatic tapers can be more efficient. The choice of edge coupler design depends on factors such as the waveguide geometry, the operating wavelength, the desired bandwidth, and the fabrication process constraints. The edge coupler material should be chosen to minimize optical losses and be compatible with the waveguide material. Silicon nitride is a suitable material due to its low loss at the operating wavelength (e.g., near 1.55 μm) and its compatibility with standard microfabrication processes. Other materials such as silicon, silicon dioxide, or certain polymers can be used depending on the specific application and waveguide material. The edge coupler dimensions are optimized to ensure efficient coupling to the input waveguide. The coupler's width and height should match the dimensions of the on-chip waveguide, while its length influences coupling efficiency and bandwidth. Precise control over these dimensions is essential for maximizing coupling efficiency and minimizing back reflections. The edge coupler is typically aligned with the input waveguide to maximize coupling efficiency, and the alignment process requires high precision to minimize losses. Automated alignment systems or other alignment techniques are commonly employed, ensuring accurate positioning of the waveguide relative to the edge coupler. The edge coupler can incorporate additional features or structures to enhance performance or functionality. For example, a grating structure etched into the coupler can improve coupling efficiency or provide wavelength selectivity, and an integrated heater or temperature sensor enables thermal control of the coupler's properties, improving stability. The edge coupler may be designed to be polarization-insensitive, minimizing variations in coupling efficiency due to changes in the input light's polarization state. The edge coupler is connected to the substrate-supported waveguides (209) on the frame (201), providing a path for the coupled light to reach the microresonator (205) via the waveguide transition (208) and the waveguides on the legs (203).

The dark pixel waveguide input edge coupler (214) plays a role in enhancing the stability and accuracy of the bolometer-optical microresonator infrared sensor (200) by enabling temperature compensation. This edge coupler functions similarly to the bright pixel waveguide input edge coupler (213), efficiently coupling light from an external source into the waveguide circuitry of a dark pixel (218). The dark pixel, shielded from incident infrared radiation (230), serves as a reference, its response reflecting ambient temperature fluctuations and other environmental factors, but not the target IR signal. The edge coupler is typically located on the frame (201) and precisely aligned with the input waveguide (227) carrying light from a tunable laser source (226). The edge coupler design should maximize coupling efficiency, minimizing signal loss during the transition from the external waveguide (usually an optical fiber) to the on-chip waveguides (209). Various edge coupler designs, including grating couplers, etched facet couplers, and inverse taper couplers can be used. Grating couplers offer broadband operation and ease of fabrication, utilizing diffraction. Etched facet couplers, using a precisely angled edge, provide high coupling efficiency. Inverse taper couplers offer a balance of efficiency and ease of fabrication, gradually changing waveguide dimensions. The choice depends on factors such as waveguide geometry, operating wavelength, and fabrication processes. The edge coupler material influences optical losses and should be compatible with the waveguide material. Silicon nitride is commonly used for its low loss at 1.55 μm and compatibility with microfabrication. Silicon, silicon dioxide, or polymers may be used if suitable. The edge coupler's physical dimensions are designed to ensure efficient coupling to the input waveguide. The coupler width and height should match the on-chip waveguide's dimensions. Precise control of these dimensions maximizes coupling efficiency and minimizes back reflections. Edge coupler widths and heights range from 0.5 μm to 2 μm, specifically from 0.75 μm to 1.5 μm. The edge coupler length influences coupling efficiency and bandwidth, and typical lengths range from a few micrometers to tens of micrometers, specifically from 5 μm to 50 μm. Precise alignment between the edge coupler and the input waveguide is essential for efficient coupling and minimizing insertion loss. Automated alignment systems or active alignment techniques, using feedback control, optimize coupling. Additional features enhance the edge coupler's functionality or performance. A grating structure can improve coupling or provide wavelength selectivity. Integrated heaters or temperature sensors provide thermal control, improving stability. The edge coupler may be designed to be polarization-insensitive, reducing variations in coupling efficiency due to the input light's polarization. The edge coupler connects to the substrate-supported waveguides (209) on the frame (201), routing light to the dark pixel (218) microresonator (205) via the waveguide transition (208) and the leg waveguides (203). The dark pixel, shielded from incident IR radiation by a radiation shield (219), serves as a reference, its response used to compensate for ambient temperature fluctuations or other environmental factors by comparing the output of the bright and dark pixels and adjusting the laser output as needed using a feedback loop.

The bright pixel waveguide output edge coupler (215) efficiently couples light from the sensor's output waveguide (229) to a photodiode (228) for detection and measurement. This edge coupler, similar in design and function to the input edge couplers (213, 214), is typically located on the frame (201) of the sensor and precisely aligned with the output waveguide, which carries the modulated light signal from the microresonator (205). The edge coupler design should maximize coupling efficiency, minimizing signal loss during the transition from the on-chip waveguides (209) to the output waveguide, usually an optical fiber. Various edge coupler designs can be employed, each having its own advantages and trade-offs. Grating couplers, based on diffraction of light, provide broadband operation and case of fabrication, though they typically have lower coupling efficiency than other types. Etched facet couplers, which rely on a precisely angled or cleaved edge, offer high coupling efficiency but are more sensitive to fabrication variations. Inverse taper couplers, which use a gradual reduction in waveguide dimensions, offer a balance of high coupling efficiency, broader bandwidth, and relaxed alignment tolerances, while adiabatic tapers are even more efficient and have even broader bandwidths. The choice of edge coupler design depends on various factors such as waveguide geometry, operating wavelength, and fabrication process capabilities. The coupler material should be chosen to minimize optical losses and be compatible with both the waveguide material and the photodiode's active area material. Silicon nitride is often preferred for its low loss at the operating wavelength (e.g., near 1.55 μm) and its compatibility with standard microfabrication processes. Other materials, such as silicon, silicon dioxide, or certain polymers, can be used. The edge coupler's dimensions, such as width, height, and length, influence coupling efficiency and bandwidth. The coupler width and height should be matched to the dimensions of the on-chip waveguide to maximize coupling efficiency. The length of the coupler affects its bandwidth and sensitivity to fabrication variations. Typical edge coupler widths and heights range from 0.5 μm to 2 μm, specifically from 0.75 μm to 1.5 μm, and more specifically approximately 1 μm, while lengths range from a few micrometers to tens of micrometers, specifically from 5 μm to 50 μm, and more specifically approximately 25 μm. Precise alignment between the edge coupler and the output waveguide is essential for minimizing coupling losses. Automated alignment systems or active alignment techniques using feedback control optimize coupling and minimize variations. The edge coupler design can incorporate additional features, such as gratings, to improve coupling efficiency or provide wavelength selectivity. Integrated heaters or temperature sensors enable thermal control of the coupler properties, thus improving stability. The edge coupler may be designed to be polarization-insensitive, mitigating variations in coupling efficiency due to changes in the input light's polarization. The edge coupler is connected to the substrate-supported waveguides (209) on the frame (201), providing a path for the modulated light signal from the microresonator (205) to reach the photodiode (228). The photodiode output is then amplified, processed, and analyzed to extract information about the incident IR radiation (230).

The dark pixel waveguide output edge coupler (216) is a component in dual-pixel configurations of the bolometer-optical microresonator infrared sensor (200), enabling temperature compensation and enhancing measurement accuracy. Similar in design and function to the bright pixel output edge coupler (215), the dark pixel edge coupler efficiently transfers light from the dark pixel's (218) output waveguide (229) to a photodiode (228) for detection. The dark pixel, shielded from incident infrared radiation (230) by a radiation shield (219), acts as a reference, its response reflecting changes in ambient temperature and other environmental factors, but not the target IR signal. The edge coupler, located on the frame (201), is precisely aligned with the dark pixel output waveguide to maximize coupling efficiency and minimize signal losses. The coupler's design typically involves a gradual change in waveguide dimensions to match the mode field profile of the on-chip waveguide (209) to that of the output waveguide (typically an optical fiber). Various coupler designs, including grating couplers, etched facet couplers, and inverse taper couplers can be employed. Grating couplers use diffraction for broadband operation. Etched facet couplers use a precisely angled edge for high coupling efficiency but increased sensitivity to fabrication variations. Inverse taper couplers offer a compromise between efficiency, bandwidth, and fabrication tolerances. Adiabatic tapers maximize both coupling efficiency and bandwidth. The choice of design depends on the specific waveguide geometry, operating wavelength, desired bandwidth, and fabrication constraints. The edge coupler material should have low optical loss at the operating wavelength near 1.55 μm and be compatible with the waveguide material and the photodiode's active area. Silicon nitride is often chosen for its low loss and compatibility with silicon-based fabrication processes, but other materials such as silicon, silicon dioxide, or certain polymers are possible. The edge coupler's dimensions are optimized to maximize coupling efficiency and minimize signal losses, and the coupler's width and height should be matched to the dimensions of the on-chip waveguide. The coupler length influences coupling efficiency, bandwidth, and sensitivity to fabrication errors, with longer couplers generally offering higher efficiency and broader bandwidth. Typical coupler widths and heights range from 0.5 μm to 2 μm, specifically from 0.75 μm to 1.5 μm, and more specifically approximately 1 μm, while lengths range from a few micrometers to tens of micrometers, specifically from 5 μm to 50 μm, and more specifically approximately 25 μm. Precise alignment between the edge coupler and the output waveguide minimizes coupling losses, typically achieved using automated alignment systems or active alignment techniques. The edge coupler may incorporate additional features to improve performance or functionality, such as a grating for higher coupling efficiency or wavelength selectivity or integrated heaters or temperature sensors for thermal control and stability. Polarization-insensitive designs minimize variations in coupling efficiency caused by changes in the input light's polarization. The edge coupler connects to the substrate-supported waveguides on the frame, providing a path for the optical signal from the dark pixel microresonator to the photodiode. The photodiode output is then used in a feedback loop to compensate for temperature changes affecting the bright pixel measurement.

The bright pixel (217) is a sensing element in the bolometer-optical microresonator infrared sensor (200), designed to detect rapid changes in incident infrared (IR) radiation (230). It comprises the island (204), microresonator (205), absorber (206), and waveguide coupler (207), all working together to transduce incident IR radiation into a measurable optical signal. The absorber captures the incident IR radiation, converting it into heat. The absorber is thermally coupled to the microresonator through the island, which is thermally isolated from the surrounding frame (201) by the legs (202, 203) to maximize temperature changes due to absorbed radiation. This temperature change induces a shift in the microresonator's resonance frequency due to the thermo-optic effect, where the refractive index changes with temperature. The microresonator, implemented as a high-Q optical cavity such as a ring resonator, is probed with light from a tunable continuous wave laser (226), coupled into the microresonator by the waveguide coupler. Changes in the microresonator's resonance frequency modulate the intensity of the transmitted light, and this modulated light is coupled out of the sensor through the output waveguides and edge couplers and directed to a photodiode (228) for detection and measurement. The bright pixel design maximizes sensitivity, speed, and stability. The thermal isolation of the island maximizes temperature changes for a given incident IR power. The high-Q microresonator amplifies the sensor's response to these temperature changes. The efficient waveguide coupling minimizes signal loss. The pixel's size and shape depend on the specific application and the dimensions of the microresonator and absorber. Pixel sizes range from a few micrometers to hundreds of micrometers, specifically from 10 μm to 200 μm, and more specifically approximately 50 μm. The bright pixel materials are chosen for their thermal, mechanical, and optical properties. Silicon nitride is a preferred material for the island, microresonator, and waveguide coupler due to its low thermal conductivity, high mechanical strength, and good optical properties at 1.55 μm. The absorber material is selected to have a large absorption coefficient at the target IR wavelength range. Metals, like gold or aluminum, or other absorbing materials, including carbon nanotubes or graphene, may be employed, depending on the operating wavelength. The bright pixel may incorporate additional features, such as integrated heaters or temperature sensors, for thermal control and calibration. The microresonator dimensions, absorber geometry, and waveguide coupling parameters are carefully designed to maximize sensitivity, speed, and stability for the specific target wavelength. The bright pixel design allows it to be integrated into larger sensor arrays. Multiple bright pixels, each with its own microresonator, absorber, and waveguides, may be arranged on a common frame, enabling high-resolution thermal imaging or spectroscopic measurements. The waveguides can be configured for wavelength-division multiplexing, allowing simultaneous readout of multiple pixels using a single waveguide and photodiode. Each pixel's microresonator is tuned to a slightly different resonance frequency, allowing each pixel to be addressed by a different wavelength of light.

The dark pixel (218) is an element in dual-pixel configurations of the bolometer-optical microresonator infrared sensor (200), serving as a reference sensor for temperature compensation and enhancing the accuracy and stability of the measurements. The dark pixel can be structurally identical to the bright pixel (217), including an island (204), a microresonator (205), an absorber (206), and a waveguide coupler (207), and it is shielded from incident infrared radiation (230) by a radiation shield (219). This shielding ensures that the dark pixel's response reflects only changes in ambient temperature and other environmental factors, and not the target IR signal. By comparing the signals from the bright and dark pixels, common-mode noise and drift caused by temperature fluctuations or other environmental variations can be effectively cancelled out. The dark pixel's dimensions, materials, and operating parameters are typically identical to those of the bright pixel to maximize common-mode rejection. The island size, microresonator dimensions, absorber geometry, and waveguide coupling parameters are chosen to match those of the bright pixel, ensuring that both pixels respond similarly to changes in ambient conditions. The dark pixel materials should also match those of the bright pixel. Silicon nitride is typically used for the island, microresonator, and waveguide coupler due to its low thermal conductivity, high mechanical strength, and good optical properties. The absorber material in the dark pixel is chosen to have a response similar to the bright pixel absorber. The dark pixel is connected to the same substrate-supported waveguides (209) and edge couplers (214, 216) as the bright pixel. The dark pixel output edge coupler (216) routes light from the dark pixel output to a photodiode (228) for measurement. The signal from the dark pixel photodiode is then typically used in a feedback loop to control the tunable laser's (226) output frequency (232), maintaining a constant operating point on the microresonator's resonance line, which enhances stability. The dark pixel waveguide input edge coupler (214) couples light from the laser into the sensor. The dark pixel may incorporate additional features such as integrated heaters or temperature sensors for thermal control and calibration, to improve overall performance and enhance the effectiveness of the temperature compensation scheme. The dark pixel is typically located on the same frame (201) as the bright pixel, minimizing thermal gradients and improving common-mode rejection. The radiation shield effectively isolates the dark pixel from incident IR radiation, and the shield may include an aperture allowing controlled exposure to the incident radiation for testing or calibration purposes.

The radiation shield (219) is a component in dual-pixel configurations of the bolometer-optical microresonator infrared sensor (200), ensuring the accurate and stable operation of the dark pixel (218) for temperature compensation purposes. The radiation shield is typically a thin, opaque film deposited and patterned onto the sensor chip, specifically on the frame (201) above the dark pixel, effectively blocking incident infrared radiation (230) from reaching the dark pixel's absorber (206). This shielding ensures that the dark pixel's response is solely due to changes in ambient temperature and other environmental factors, and not influenced by the target IR signal. The radiation shield material should be opaque or highly reflective at the wavelengths of interest to effectively block or deflect incident radiation. Metals such as gold, aluminum, or titanium are commonly employed due to their high reflectivity and compatibility with standard microfabrication processes. Other materials, including opaque polymers or dielectric films with high reflectivity coatings, are also potential candidates. The radiation shield dimensions and shape are designed to completely cover the dark pixel's absorber while minimizing any impact on other sensor components. Its size should match the dark pixel's absorber area while its shape can be adapted to accommodate the sensor layout. Typical radiation shield dimensions range from a few micrometers to hundreds of micrometers, matching the pixel size, specifically from 10 μm to 200 μm, and more specifically approximately 50 μm. The shield thickness is chosen to ensure sufficient blocking of the incident radiation while minimizing the added thermal mass and any stress or strain on the sensor chip, typically ranging from a few nanometers to several micrometers, specifically from 100 nm to 10 μm, and more specifically about 1 μm. The radiation shield is typically patterned using standard lithographic techniques, and its shape can be adjusted to accommodate various sensor designs and pixel layouts. For instance, in sensor arrays with multiple bright and dark pixels, the radiation shield may be a continuous film covering all dark pixels or individual shields for each dark pixel. The radiation shield can incorporate an aperture or window to allow controlled exposure of the dark pixel to the incident radiation for testing or calibration purposes. The aperture size and shape can be precisely defined using lithography. The radiation shield is mechanically attached to the frame (201) of the sensor, ensuring stable positioning and minimizing vibrations or movement that could affect its shielding effectiveness. The shield can be integrated with other on-chip components, such as heaters or temperature sensors, to enable thermal control or monitoring of the dark pixel. In some embodiments, the radiation shield material may serve a dual purpose, acting as both a shield and an electrical interconnect or ground plane.

The silicon nitride layer (220) is a component in the fabrication of the bolometer-optical microresonator infrared sensor (200), serving as the base material for many of the sensor's key structural and optical elements. This layer is typically deposited onto a silicon substrate (221), which provides mechanical support for the sensor chip. The silicon nitride layer is subsequently patterned and etched to define the microresonator (205), waveguide coupler (207), legs (202, 203), and frame (201). Silicon nitride is chosen for this layer due to its unique combination of material properties. Its low thermal conductivity is critical for achieving high thermal isolation, which maximizes the sensor's sensitivity to absorbed IR radiation. Its high mechanical strength and Young's modulus ensures the structural integrity of the freestanding legs and island (204). Its excellent optical properties, including high refractive index and low optical loss at the sensor's operating wavelength (e.g., near 1.55 μm), enable efficient waveguiding and enhance the performance of the microresonator. The silicon nitride layer can be deposited using various techniques, including low-pressure chemical vapor deposition (LPCVD) and plasma-enhanced chemical vapor deposition (PECVD). LPCVD offers excellent control over film thickness, uniformity, and material properties, producing high-quality, low-stress films suitable for microresonator fabrication. PECVD provides higher deposition rates and good conformality, advantageous for coating complex structures, but may result in films with higher stress. Other deposition techniques, such as sputtering, can be used to deposit silicon nitride films with varying stoichiometry, enabling control over the material's refractive index. The thickness of the silicon nitride layer (220) influences both the thermal and mechanical properties of the sensor components. Thicker films provide greater mechanical strength, but also increase thermal mass, which may slow the thermal response time, decreasing bandwidth. Thinner films reduce thermal mass, enhancing speed, but they are more susceptible to mechanical deformation or failure. Typical silicon nitride layer thicknesses range from 100 nm to 1 μm, specifically from 200 nm to 500 nm, and more specifically approximately 300 nm. The optimal thickness balances thermal and mechanical considerations and depends on the specific sensor design and application requirements. The deposition conditions, including temperature, pressure, and gas flow rates, are carefully controlled to achieve the desired film properties. The surface of the silicon nitride layer can be further treated or modified to improve adhesion, reduce roughness, or enhance other relevant properties. For example, a thin adhesion layer, such as chromium or titanium, may be deposited prior to silicon nitride deposition to improve its bonding to the silicon substrate. After deposition, the silicon nitride layer may be annealed at elevated temperatures to reduce stress, improve film density, and enhance optical properties. The annealing temperature, duration, and atmosphere are optimized based on the specific silicon nitride material and the sensor's performance requirements. Temperatures typically range from 800° C. to 1200° C., held for durations from 30 minutes to 2 hours. The annealing is performed under vacuum or in an inert gas environment such as nitrogen or argon.

The silicon substrate (221) provides the foundation for the bolometer-optical microresonator infrared sensor (200), serving as the mechanical support and base material for the sensor chip. The silicon substrate is typically a standard silicon wafer, chosen for its excellent mechanical properties, compatibility with well-established microfabrication processes, high availability, and cost-effectiveness. Alternative substrate materials, including glass, quartz, sapphire, or other materials with suitable mechanical and thermal properties, can be employed depending on the application's specific requirements. Glass substrates, for instance, offer excellent transparency and thermal stability, beneficial for certain optical sensing applications. Quartz substrates exhibit low thermal expansion and are useful for high-precision devices. The silicon substrate's dimensions typically match standard wafer sizes, facilitating compatibility with existing microfabrication equipment and processes. Typical wafer diameters range from 50 mm to 300 mm, specifically from 100 mm to 200 mm, and more specifically approximately 150 mm. The substrate thickness affects mechanical stability and chip handling. Thicker substrates offer greater robustness but may increase thermal mass and limit thermal response time. Substrate thicknesses range from 100 μm to 1000 μm, specifically from 200 μm to 500 μm, and more specifically approximately 250 μm. The silicon substrate serves as the base for depositing the silicon nitride layer (220), forming the initial layers of the sensor structure. The substrate's surface properties, including roughness and cleanliness, influence the quality and adhesion of the deposited films. Prior to deposition, the substrate is typically cleaned and treated to remove contaminants and improve surface adhesion. Various surface treatments, including wet chemical cleaning, plasma cleaning, or the application of adhesion promoters, can be employed. The silicon substrate also plays a role in the thermal management of the sensor. Silicon has relatively high thermal conductivity, which helps to dissipate heat from the sensor chip, reducing temperature gradients and enhancing stability. For applications requiring more stringent temperature control, the substrate can be integrated with a thermoelectric cooler or other temperature control elements. The silicon substrate can be further processed or modified to enhance sensor performance or integration. For example, electrical interconnects or other circuitry can be fabricated on the backside of the substrate, simplifying connections to external electronics. Through-holes or vias can be etched into the substrate to facilitate fluidic connections or enable three-dimensional sensor architectures. The substrate can be patterned or etched to create microfluidic channels or other microstructures for integrating the sensor with lab-on-a-chip or other microfluidic devices.

The absorber material (222) is a component in the fabrication of the bolometer-optical microresonator infrared sensor (200), forming the basis for the absorber (206) that captures incident infrared (IR) radiation. The absorber material is deposited onto the island (204) and subsequently patterned and etched to define the final absorber geometry. The absorber material's primary function is to efficiently convert incident IR radiation into heat, thereby raising the temperature of the island and, consequently, the microresonator (205). The choice of absorber material depends primarily on the target wavelength range and desired absorption characteristics. The material should exhibit a high absorption coefficient at the wavelengths of interest, minimizing reflection and transmission losses. Its thermal properties, including thermal conductivity and heat capacity, should be compatible with the sensor design and desired response time. For broadband IR absorption, materials such as carbon nanotubes, graphene, or other blackbody-like materials can be employed. These materials offer high absorption across a wide range of wavelengths, simplifying design and fabrication for broadband applications. For narrowband or wavelength-selective absorption, metals like gold, aluminum, or titanium are suitable. These materials can be patterned into frequency selective surfaces (FSS) or metamaterial absorbers, engineered to exhibit strong absorption at specific wavelengths. The absorber material thickness affects absorption efficiency and thermal response time. Thicker films generally increase absorption but may also increase thermal mass, slowing down the sensor's response. Thicker films can also introduce stress or strain, which can affect sensor performance and long-term stability. Thinner films reduce thermal mass, enabling faster response times, but may have lower absorption efficiency. Typical absorber material thicknesses range from a few nanometers to several micrometers, specifically from 10 nm to 1 μm, and more specifically approximately 100 nm, carefully balanced to optimize absorption and response time. The absorber material deposition method influences film quality, uniformity, and compatibility with other fabrication processes. Physical vapor deposition (PVD), sputtering, pulsed laser deposition (PLD), and chemical vapor deposition (CVD) are commonly used techniques, each offering unique advantages and limitations. PVD and sputtering provide good control over film thickness and uniformity, especially for metallic films. PLD enables deposition of complex materials and precise control over stoichiometry. CVD is well-suited for depositing thin films with high purity and conformality and allows for controlling the material's stoichiometry by adjusting gas flow rates. The absorber material may incorporate additional layers or features to enhance performance. An adhesion layer, such as titanium or chromium, deposited between the absorber material and the island, can improve bonding and reduce delamination or peeling. A thin passivation layer, typically silicon dioxide or silicon nitride, deposited on top of the absorber, can protect it from environmental factors such as oxidation or contamination. The absorber material can be integrated with other on-chip components such as filters or polarizers, to enhance wavelength selectivity or polarization sensitivity.

The silicon dioxide layer (223) can be a component in the fabrication of the bolometer-optical microresonator infrared sensor (200), functioning as an isolation layer within the sensor's layered structure on the frame (201). Deposited onto the frame, specifically between the underlying silicon nitride layer (220) and a subsequent silicon nitride layer (224), the silicon dioxide layer (223) serves to isolate the substrate-supported waveguides (209) and edge couplers (213-216) formed in the top silicon nitride layer (224), improving sensor performance and reducing signal loss. The silicon dioxide's low refractive index compared to silicon nitride ensures that light remains confined within the silicon nitride waveguides, reducing leakage or crosstalk between adjacent waveguides and improving transmission efficiency. Silicon dioxide's excellent dielectric properties also minimize coupling between the waveguides and the underlying substrate, enhancing sensor stability. The silicon dioxide layer is typically deposited using plasma-enhanced chemical vapor deposition (PECVD), a technique offering good control over film thickness, uniformity, and conformality, ensuring uniform coverage over the underlying topography, crucial for isolating the waveguides and edge couplers effectively. Alternative deposition techniques, including sputtering, evaporation, or low-pressure chemical vapor deposition (LPCVD), may be used depending on the specific requirements of the sensor design and available fabrication capabilities. The thickness of the silicon dioxide layer (223) influences its isolation effectiveness and the overall sensor performance. Thicker layers generally provide better isolation but also increase the overall sensor thickness, which could introduce stress or strain during fabrication. The thickness should be sufficient to effectively isolate the waveguides but not so thick as to compromise the sensor's structural integrity or thermal performance. Typical silicon dioxide layer thicknesses range from 50 nm to 500 nm, specifically from 100 nm to 250 nm, and more specifically approximately 150 nm. The deposition conditions, including temperature, pressure, and gas flow rates, are optimized to achieve the desired film quality, uniformity, and conformality, crucial for its function as an isolation layer. The silicon dioxide layer may be subjected to post-deposition annealing to further improve its properties or reduce stress. The annealing temperature and duration depend on the specific application and film characteristics. The silicon dioxide layer can be patterned or etched if necessary to accommodate vias or other structures for electrical interconnects or other components, which might be needed for integrating the sensor with other devices or systems.

The silicon nitride layer (224) deposited onto the frame (201) is a component in the fabrication of the bolometer-optical microresonator infrared sensor (200), serving as the waveguide material for the substrate-supported waveguides (209) and edge couplers (213-216). These waveguides and couplers are essential for routing optical signals on the sensor chip and efficiently coupling light to and from external optical fibers or other components. The silicon nitride layer (224) can be deposited on top of a silicon dioxide layer (223) or other material, which acts as an isolation layer, preventing leakage of light into the substrate. Silicon nitride is chosen for its excellent optical properties at the sensor's operating wavelength, including a high refractive index and low optical loss. The high refractive index enables efficient light confinement within the waveguides, while the low loss minimizes signal attenuation during propagation, maximizing the optical power delivered to the microresonator (205) and enhancing the sensor's sensitivity. The silicon nitride layer (224) can be deposited using various methods, including low-pressure chemical vapor deposition (LPCVD) and plasma-enhanced chemical vapor deposition (PECVD). LPCVD offers precise control over film thickness, uniformity, and material properties, essential for achieving low-loss waveguides. PECVD allows for higher deposition rates and better conformality, advantageous for coating complex structures, but may produce films with higher stress, impacting long-term stability. Sputtering or other deposition techniques can also be used, enabling variations in stoichiometry and control over refractive index. The thickness of the silicon nitride layer (224) affects the waveguide properties and overall sensor performance. Thicker films generally support stronger light confinement and may be preferred for minimizing waveguide bends, however thicker films also increase material cost. Typical silicon nitride layer thicknesses for this application range from 100 nm to 1 μm, specifically from 200 nm to 500 nm, and more specifically approximately 300 nm. The optimal thickness depends on the waveguide design, the desired optical properties, and the fabrication process constraints. The deposition conditions, including substrate temperature, pressure, and gas flow rates, are carefully controlled to achieve the desired film properties. Post-deposition annealing may be employed to further improve the silicon nitride's quality, reduce stress, enhance its optical properties, and improve long-term stability. Annealing temperatures typically range from 800° C. to 1200° C. for durations between 30 minutes and 2 hours. The annealing atmosphere may be inert (e.g., nitrogen or argon) or reactive (e.g., oxygen or forming gas), chosen to minimize impurities or optimize stoichiometry. The silicon nitride layer (224) is subsequently patterned and etched to define the waveguides and edge couplers. The waveguide dimensions, including width and height, determine its mode profile and propagation characteristics, while the edge coupler geometry influences coupling efficiency to optical fibers or other components. Precise control over these dimensions is achieved using high-resolution lithography, such as electron beam lithography or deep-ultraviolet (DUV) lithography, and precise dry etching techniques.

The waveguides (225) formed on the legs (203) are low-loss conduits for transmitting light to and from the microresonator (205) located on the thermally isolated island (204). These waveguides are formed by patterning a ridge (211) into the silicon nitride legs, creating a waveguide structure that confines and guides light along the legs. This integrated design minimizes the sensor's footprint and simplifies fabrication, eliminating the need for separate waveguide components. The waveguides connect the waveguide coupler (207) on the island to the waveguide transitions (208) on the frame (201), establishing a continuous optical path between the microresonator and the substrate-supported waveguides (209). Light from a tunable laser source (226) is coupled into the sensor through the input edge coupler (213) and routed through the substrate-supported waveguides, the waveguide transitions, and finally through the waveguides on the legs to the waveguide coupler and into the microresonator. The waveguides function is to transmit light with minimal loss, maximizing the optical power delivered to the microresonator and the signal collected from it. The waveguide material should have a high refractive index to confine light effectively, and should exhibit low optical absorption at the sensor's operating wavelength (e.g., near 1.55 μm) to minimize transmission losses. Silicon nitride, the material typically used for the legs, is an excellent choice for the waveguides due to its combination of high refractive index, low optical loss, and compatibility with standard microfabrication techniques. The waveguide geometry is typically a ridge structure, where a raised ridge is patterned into the silicon nitride legs. The ridge width (211) and height influence the waveguide's optical properties, including its mode profile, effective refractive index, and propagation losses. Narrower ridge widths improve light confinement and reduce propagation losses, but they also increase sensitivity to fabrication imperfections. Wider ridge widths offer greater tolerance to fabrication variations, but may support multiple optical modes, leading to modal dispersion. The ridge height influences the waveguide's effective refractive index, affecting light confinement and propagation loss. Typical ridge widths range from 0.5 μm to 2 μm, specifically from 0.75 μm to 1.5 μm, and more specifically approximately 1 μm. Ridge heights typically range from 0.1 μm to 1 μm, specifically from 0.2 μm to 0.5 μm, and more specifically approximately 0.3 μm. The waveguide length, determined by the length of the legs (212), affects the total propagation loss. While longer waveguides increase the total path length and therefore losses, longer legs are beneficial for thermal isolation. The waveguide design should minimize bending or other sharp features, as these introduce additional losses due to scattering or mode mismatch. The waveguides may be designed for single-mode or multi-mode operation. Single-mode waveguides support only one spatial mode of light, minimizing modal dispersion and ensuring high spectral resolution. Multi-mode waveguides can carry more optical power but may exhibit modal dispersion, potentially degrading sensor performance. The choice of waveguide design depends on the specific application requirements and the characteristics of the light source. The waveguides on the legs connect to the waveguide coupler (207) on the island (204). The waveguide coupler facilitates efficient transfer of light between the leg waveguides and the microresonator (205). At the other end, the leg waveguides connect to the waveguide transitions (208) on the frame (201), which smoothly transfer the optical signal to and from the substrate-supported waveguides (209).

The tunable continuous wave (CW) laser (226) provides the light source for probing the microresonator (205) and enabling sensitive detection of changes in its resonance frequency. The laser's tunability allows precise adjustment of its emission wavelength to match a resonance of the microresonator, maximizing the sensor's response to changes in absorbed IR radiation (230). Continuous wave operation ensures a stable, narrow-linewidth optical signal, minimizing noise and enhancing detection sensitivity. The laser wavelength is typically chosen to be near 1.55 μm, corresponding to the low-loss telecommunications band, facilitating the use of readily available and cost-effective optical components, including single-mode optical fibers and waveguides. Various types of tunable lasers can be employed, each offering advantages and disadvantages in terms of tuning range, linewidth, output power, and stability. External cavity diode lasers (ECDLs) provide wide tuning ranges and narrow linewidths, essential for resolving the sharp resonance lines of high-Q microresonators, while their output power and stability can be enhanced using additional control electronics. Distributed feedback (DFB) lasers offer good stability and narrow linewidths but typically provide smaller tuning ranges, suitable when the microresonator's resonance frequency is known precisely and not expected to drift significantly. Fiber lasers, based on doped optical fibers as the gain medium, offer broad tuning ranges, high output power, and excellent stability but may have larger linewidths and can be more expensive, often preferred for applications requiring high optical power or broad wavelength coverage. The laser output power influences the strength of the photothermal feedback in the sensor, and should be chosen to optimize sensitivity, bandwidth, and stability. Typical output powers range from 1 microwatt to 100 milliwatts, specifically from 100 μW to 10 mW, and more specifically approximately 1 mW. Higher powers increase the photothermal feedback strength, enhancing sensor bandwidth, but may also introduce thermal noise or instability. The laser linewidth, a measure of its spectral purity, is another critical parameter, as narrower linewidths reduce noise and improve spectral resolution, important for spectroscopic applications or when probing narrow resonance lines. Linewidths typically range from 100 kHz to 10 MHZ, specifically from 1 MHz to 5 MHz, and more specifically approximately 2 MHZ. Active stabilization of the laser frequency (232) enhances long-term stability and reduces noise by locking the laser frequency to an external reference such as a stable optical cavity (233) or an atomic transition line. Various locking techniques, including the Pound-Drever-Hall (PDH) method, can be employed to achieve high stability and low noise. The laser's output is typically coupled to the sensor (200) using an optical fiber (227) connected to an edge coupler (213, 214) on the sensor chip. Efficient coupling minimizes signal loss and maximizes the power delivered to the microresonator. The laser can be modulated at a microwave frequency (231) using an external modulator to generate sidebands on the laser's emission line. This modulation enhances detection sensitivity or can allow simultaneous addressing of multiple sensor pixels using wavelength-division multiplexing. The modulation frequency and depth are chosen based on the desired sensor bandwidth and the spectral characteristics of the microresonator.

The input waveguide (227) delivers light from the tunable continuous wave laser (226) to the sensor chip. The input waveguide is typically a standard single-mode optical fiber, chosen for its low loss at the operating wavelength, wide availability, case of handling, and compatibility with various optical components and test equipment. Other types of waveguides, such as polarization-maintaining fibers or lensed fibers, can be employed depending on the specific application's polarization or coupling requirements. The input waveguide (227) is connected to the sensor chip via an edge coupler. The fiber tip is carefully aligned with the edge coupler to maximize coupling efficiency, minimizing signal loss during the transition from the fiber to the on-chip waveguides (209). Various coupling techniques, including butt coupling, lens coupling, or grating coupling can be used. Butt coupling involves aligning the fiber tip directly to the edge coupler. Lens coupling employs a lens to focus the light from the fiber onto the edge coupler. Grating coupling uses a diffraction grating etched into the sensor chip, allowing for more compact integration but may limit bandwidth. The choice of coupling method depends on the edge coupler design, the required coupling efficiency, and alignment tolerances. Precise alignment is critical for maximizing coupling efficiency and minimizing back reflections, improving sensor performance and stability. Automated alignment systems or active alignment techniques are employed to optimize and maintain coupling. The input waveguide can incorporate additional components to modify or control the light before it enters the sensor, such as a fiber polarizer to control the input polarization state. A fiber attenuator can adjust the optical power delivered to the sensor, which may be required to optimize the strength of the photothermal feedback and stabilize the sensor's response. A fiber isolator can prevent back reflections from the sensor from entering the laser, thus enhancing its stability, which is particularly important for lasers sensitive to back reflections. A wavelength-division multiplexer (WDM) can combine light from multiple laser sources into a single fiber, which can be used to address different sensor elements or perform spectroscopic measurements using multiple wavelengths simultaneously.

The photodiode (228) converts the optical signal from the sensor's output waveguide (229) into a measurable electrical signal. This electrical signal carries information about changes in the microresonator's (205) resonance frequency, which, in turn, reflects variations in the intensity of incident infrared radiation (230). The photodiode material and design are chosen to optimize its performance at the operating wavelength of the sensor system, typically near 1.55 μm, corresponding to the low-loss telecommunications band. Common photodiode materials for this wavelength range include indium gallium arsenide (InGaAs) or germanium (Ge). InGaAs photodiodes offer high responsivity and speed, enabling sensitive detection of rapid changes in light intensity. Germanium photodiodes extend the detectable wavelength range further into the infrared but may have lower responsivity. The photodiode structure can vary depending on the specific application requirements. PIN photodiodes, comprising a p-type, intrinsic, and n-type semiconductor layers provide a simple and widely used structure with good responsivity and speed. Avalanche photodiodes (APDs) incorporate an internal gain mechanism, amplifying the photocurrent and enhancing sensitivity for low-light applications. However, APDs require higher operating voltages and may exhibit higher noise levels. The photodiode size influences its responsivity and capacitance. Larger photodiodes capture more light, increasing responsivity, but also exhibit larger capacitance, which can limit bandwidth. Smaller photodiodes offer lower capacitance and faster response times but may have reduced responsivity. Fiber-coupled photodiodes, where the photodiode is integrated with an optical fiber pigtail, simplify connection to the sensor's output waveguide and reduce coupling losses. Free-space photodiodes, where the photodiode is mounted in a package with a window, allow for flexible coupling but typically require more careful alignment to ensure efficient light collection. Temperature stabilization of the photodiode enhances its performance by minimizing variations in responsivity caused by changes in ambient temperature. This can be achieved by integrating a thermoelectric cooler (TEC) into the photodiode package or by controlling the temperature of the sensor environment.

The output waveguide (229) transmits the modulated optical signal from the sensor chip to the photodiode (228) for detection and measurement. The output waveguide, typically a standard single-mode optical fiber, efficiently carries the light exiting the sensor's output edge coupler (215, 216) to the photodiode with minimal loss. Its low attenuation at the operating wavelength (near 1.55 μm) preserves signal strength and ensures accurate measurement of the changes in light intensity caused by variations in absorbed IR radiation. Alternative waveguide types, such as polarization-maintaining fibers, may be used depending on the specific application's requirements for polarization control or if the output of the sensor is polarization modulated. Lensed fibers, which have a lens at the tip to focus or collimate the light, might improve coupling efficiency between the sensor and the photodiode. The output waveguide (229) is connected to the sensor chip using an edge coupler (215, 216). Precise alignment between the fiber tip and the edge coupler maximizes coupling efficiency, minimizing signal loss during the transition from the on-chip waveguides (209) to the fiber. Various coupling methods, including butt coupling, where the fiber is aligned directly to the edge coupler, or lens coupling, where a lens focuses the light exiting the edge coupler onto the fiber tip, can be used. Grating coupling, employing a diffraction grating on the sensor chip, allows for more compact integration but may have limitations in terms of bandwidth or coupling efficiency. The choice of coupling technique depends on the specific edge coupler design, desired coupling efficiency, and alignment tolerance requirements. Active alignment methods, employing feedback control to optimize and maintain coupling, may be employed for enhanced stability and reduced drift. The output waveguide (229) may include additional components such as a fiber attenuator, to adjust the optical power reaching the photodiode and prevent saturation. A fiber isolator can minimize back reflections from the photodiode into the sensor, improving stability. A fiber polarizer can control the polarization state of the light reaching the photodiode, useful when polarization effects are important in the measurement. A wavelength-division multiplexer can separate the signals from multiple sensor elements, each operating at a different wavelength, useful in wavelength-division multiplexing readout schemes.

The infrared or far-infrared light (230) represents the target radiation to be detected by the bolometer-optical microresonator infrared sensor (200). This radiation, characterized by its wavelength or frequency, carries information about the temperature, composition, or other properties of the object or scene being observed. The sensor is designed to detect rapid changes in the intensity of this radiation, enabling measurements of dynamic processes or high-speed imaging. The infrared spectrum spans a wide range of wavelengths, from approximately 700 nm to 1 mm. Near-infrared (NIR) radiation, closest to the visible spectrum, has wavelengths ranging from 700 nm to 1400 nm. Short-wavelength infrared (SWIR) radiation extends from 1400 nm to 3000 nm. Mid-wavelength infrared (MWIR) radiation covers the range from 3000 nm to 8000 nm. Long-wavelength infrared (LWIR) radiation spans from 8000 nm to 15000 nm. Far-infrared (FIR) radiation occupies the longest wavelengths, from 15 μm to 1 mm. The sensor can be designed to operate in any of these wavelength ranges by selecting an appropriate absorber material (222) and optimizing the absorber geometry (206). The absorber's material and structure determine its spectral response, dictating the wavelengths of light it efficiently absorbs. For broadband detection, covering a wide range of wavelengths, materials such as carbon nanotubes or other blackbody-like materials can be employed. For narrowband or wavelength-selective detection, materials such as metals (e.g., gold, aluminum, or titanium) patterned into frequency selective surfaces (FSS) or metamaterials can be utilized. These structures are designed to resonate and absorb strongly at specific wavelengths or narrow bandwidths. The intensity of the infrared or far-infrared light (230) can vary depending on the temperature and emissivity of the source, and the sensor's dynamic range and sensitivity are key performance parameters that determine its ability to accurately measure intensity changes. The dynamic range specifies the range of intensities the sensor can measure without saturation or distortion. The sensitivity represents the minimum detectable change in intensity. These parameters depend on the sensor design, including the thermal isolation of the island (204), the quality factor of the microresonator (205), and the characteristics of the photodiode (228) and associated signal processing circuitry. The incident radiation (230) may be modulated, chopped, or otherwise modified to enhance detection sensitivity or reduce noise. Modulation techniques, such as wavelength modulation or amplitude modulation, encode the IR signal onto a specific frequency or waveform, improving signal-to-noise ratio. Chopping involves periodically interrupting the IR beam, allowing for synchronous detection, effectively suppressing background noise and drift. The incident radiation may be polarized, and the sensor can be designed to be polarization-sensitive, enabling applications such as polarimetry or remote sensing of materials with specific polarization properties. Various sources of infrared and far-infrared light can be used with the sensor. Blackbody sources, which emit radiation across a broad range of wavelengths depending on their temperature, are commonly used for calibration and testing. Lasers emitting in the infrared or far-infrared, such as quantum cascade lasers (QCLs) or gas lasers, offer narrow linewidths and high power for specific wavelength applications, useful in spectroscopy or free-space optical communications. Thermal sources, such as heated objects or flames, can also be measured with the sensor, enabling applications such as thermal imaging, remote temperature sensing, or fire detection.

The microwave frequency (231) is useful when employed in conjunction with a modulated laser source. Modulating the tunable continuous wave laser (226) at a microwave frequency creates sidebands on the laser's emission line. These sidebands can be used to enhance detection sensitivity, increase detection bandwidth, or enable simultaneous readout of multiple sensor elements. The microwave frequency is chosen based on several factors, including the desired sensor bandwidth, the spectral characteristics of the microresonator (205), and the capabilities of the modulation electronics. Higher microwave frequencies generally lead to wider detection bandwidths, enabling the sensor to capture faster changes in IR intensity. However, higher frequencies also place more stringent requirements on the modulation electronics and may be limited by the bandwidth of the photodiode (228) and associated circuitry. The microwave frequency should also be chosen to avoid interference with other signals or noise sources present in the sensor's operating environment. Typical microwave frequencies used for modulating the laser range from 1 GHz to 100 GHZ, specifically from 10 GHz to 50 GHZ, and more specifically approximately 20 GHz. These frequencies offer a balance between achieving high bandwidth and compatibility with readily available microwave components. The modulation technique influences the characteristics of the generated sidebands. Amplitude modulation (AM) varies the intensity of the laser light at the microwave frequency. Frequency modulation (FM) varies the laser's frequency or phase. Phase modulation (PM) is a specific type of frequency modulation where the phase of the laser light is varied. The choice of modulation technique depends on the specific detection scheme and desired sensor response. The modulation depth, which represents the extent of the intensity or frequency variation, is another important parameter. Larger modulation depths generally increase the strength of the sidebands, which can enhance sensitivity, but may also introduce distortions or nonlinearities in the sensor response. The modulation waveform, which can be sinusoidal, square wave, or other periodic functions, also influences the sideband characteristics and should be chosen appropriately for the specific modulation technique and application. The modulated laser light, carrying the microwave frequency sidebands, is coupled into the sensor through the input waveguide (227) and edge coupler. The sidebands interact with the microresonator, and changes in the microresonator's resonance frequency, caused by absorbed IR radiation, modulate the sidebands' intensity or phase. These modulated sidebands are then detected by the photodiode and analyzed to measure the IR intensity variations. The microwave frequency (231) can be generated using various electronic components, including voltage-controlled oscillators (VCOs), synthesizers, or other microwave sources. The frequency stability and spectral purity of the microwave source are important factors influencing the sensor's performance. High-stability microwave sources, such as those based on crystal oscillators or phase-locked loops (PLLs), minimize noise and drift in the sensor's response, enhancing accuracy and stability. The microwave signal is typically amplified before being applied to the laser modulator to achieve the desired modulation depth.

The CW laser frequency (232) can determine the sensor's sensitivity, stability, and spectral response. The CW laser frequency is the center frequency of the tunable laser's (226) emission, and this frequency is selected to interact with the microresonator's (205) resonance in a specific way to maximize the sensor's response to changes in absorbed IR radiation (230). The laser frequency is typically tuned to be near a resonance frequency of the microresonator. When the laser frequency is close to a resonance, changes in the microresonator's temperature, caused by absorbed IR radiation, shift the resonance frequency, and thus modulate the intensity of light transmitted through the microresonator. This intensity modulation is then detected by the photodiode (228), enabling measurement of the IR intensity changes. The specific operating point on the microresonator's resonance line influences the sensor's sensitivity and stability. Operating on the blue wing (higher frequency side) of the resonance maximizes sensitivity to changes in resonance frequency, while also enhancing stability due to negative photothermal feedback. Operating on the red wing (lower frequency side) can also be employed, but may lead to instability due to positive photothermal feedback. The precise value of the CW laser frequency depends on the microresonator's resonance frequency, which is determined by the resonator's geometry, dimensions, and material properties. For a ring resonator, the resonance frequencies are determined by the ring radius, waveguide width, and the refractive index of the resonator material. The CW laser frequency can be tuned to match any of these resonance frequencies, allowing flexibility in sensor design and operation. Typical CW laser frequencies used in this sensor range from 180 THz to 200 THz (corresponding to wavelengths near 1.5 μm), specifically from 190 THz to 195 THz, and more specifically approximately 193 THz. These frequencies are compatible with readily available tunable lasers and waveguide components operating in the telecommunications band. Precise control and stabilization of the CW laser frequency enhance sensor stability and reduce noise. Active stabilization techniques, such as locking the laser frequency to an external reference cavity (233) with high frequency stability or an atomic transition line, minimize drift and noise caused by fluctuations in the laser's output frequency. The locking process typically involves a feedback loop that continuously adjusts the laser's frequency to maintain a fixed frequency difference between the laser and the reference cavity. Various locking techniques, such as the Pound-Drever-Hall (PDH) method, offer different levels of precision and stability. The CW laser frequency can be modulated to implement various detection schemes, such as wavelength modulation spectroscopy (WMS). In WMS, the laser frequency is modulated at a specific frequency, and the sensor's response at the modulation frequency or its harmonics is measured. This technique enhances detection sensitivity and reduces background noise. The modulation frequency and depth are optimized based on the specific application and the spectral characteristics of the target gas or material.

The external cavity (233) enhances the stability and performance of the bolometer-optical microresonator infrared sensor (200) by providing a stable frequency reference for the tunable continuous wave laser (226). Laser frequency stability provides accurate and reliable sensor measurements, as fluctuations in the laser frequency can introduce noise and drift, reducing sensitivity and degrading the sensor's ability to detect rapid changes in IR intensity. The external cavity stabilizes the laser frequency by providing a narrow-linewidth resonance to which the laser can be locked. This locking mechanism creates a feedback loop that maintains the laser frequency at a fixed point on the external cavity's resonance line, minimizing frequency noise and drift. The external cavity can be implemented using various technologies. High-finesse optical cavities, formed by two or more highly reflective mirrors, offer extremely narrow linewidths and high stability, suitable for the most demanding applications. Fiber Bragg gratings (FBGs), which are periodic variations in refractive index within an optical fiber, provide a compact and stable resonance and are easily integrated into fiber-optic systems. Other technologies, including whispering gallery mode resonators, Fabry-Pérot interferometers, or stabilized laser diodes, can also be employed, depending on the specific performance requirements. The external cavity's linewidth, a measure of the spectral width of its resonance, determines the achievable laser frequency stability. Narrower linewidths translate to higher stability. Linewidths can range from a few kHz to several MHz, specifically from 10 kHz to 1 MHz, and more specifically approximately 100 kHz, chosen based on the sensor's noise requirements and the characteristics of the laser source. The external cavity's free spectral range (FSR), which represents the frequency spacing between adjacent resonances, is another important parameter. A larger FSR simplifies the locking process and reduces the risk of the laser hopping between different resonances, and the FSR should be larger than the tuning range of the laser and any expected frequency shifts due to environmental factors. The external cavity may include additional features to enhance performance and stability. Temperature stabilization of the cavity minimizes variations in resonance frequency caused by temperature fluctuations, thus improving long-term stability. Vibration isolation reduces noise introduced by mechanical vibrations. Active feedback control of the cavity length or other parameters allows for fine-tuning the resonance frequency and optimizing the locking process. The external cavity is typically integrated into the sensor system using optical fibers and couplers. Light from the tunable laser is coupled into the external cavity, and the reflected or transmitted light is detected and used in a feedback loop to control the laser's frequency. The locking process typically involves modulating the laser frequency and using a phase-sensitive detector to generate an error signal, which is then fed back to the laser to maintain a stable lock to the external cavity's resonance. The locking bandwidth, which represents the range of frequencies over which the feedback loop can effectively suppress frequency noise, influences the sensor's stability.

The computer (234) provides control, signal processing, data analysis, and system integration. The computer, which may be integrated into the sensor system or function as a separate unit, can be implemented using various hardware platforms. Microcontrollers, with their small size, low power consumption, and real-time control capabilities, are well-suited for embedded applications where space and power are limited. Field-programmable gate arrays (FPGAs), which offer high processing speeds and parallel processing capabilities, are advantageous for applications requiring complex signal processing or real-time data analysis. Digital signal processors (DSPs), optimized for signal processing tasks, provide high performance and low power consumption for applications involving filtering, noise reduction, or other signal conditioning operations. General-purpose computers, such as desktop PCs or laptops, offer high processing power and flexibility, and are suitable for data analysis, visualization, or system control in laboratory or research settings. The choice of computer hardware depends on factors such as the complexity of the algorithms implemented, required processing speed, power constraints, size limitations, and cost considerations. The computer interfaces with the sensor system through various input and output channels. Analog-to-digital converters (ADCs) convert analog signals from the photodiode (228) into digital data for processing by the computer. Digital-to-analog converters (DACs) convert digital control signals from the computer into analog voltages or currents for controlling the laser (226) wavelength, power, or modulation. Digital input/output (DIO) interfaces enable communication with other digital components, such as switches, sensors, or actuators, within the sensor system. Communication interfaces, such as USB, Ethernet, or wireless protocols, allow data transfer and control of the sensor by external devices or systems. The computer's operating system and software provide the environment for executing control algorithms, signal processing routines, and other sensor-related functions. The software may implement various tasks, including temperature control, signal filtering, noise reduction, wavelength tuning, data acquisition, analysis, and visualization. The software can be tailored to specific application requirements and is typically designed to optimize sensor performance, stability, and ease of use. The computer can be integrated with other components of the sensor system, such as the laser driver, photodiode amplifier, or temperature controller, streamlining system design and minimizing complexity. The integration level depends on the chosen computer platform and the specific requirements of the application. The computer may be physically located near the sensor or remotely connected through a network, enabling flexible system configurations. In some embodiments, multiple computers may be employed, each performing dedicated tasks, such as real-time control, data acquisition, or data analysis, enhancing the system's capabilities and performance.

The algorithm (235) provides control, signal processing, and data analysis functions executed by a computer (234). Algorithms provide the set of instructions and calculations that govern the sensor system's operation, optimizing its performance for various applications. One function of algorithms in this context is sensor control. Algorithms can be implemented to precisely tune the laser (226) wavelength, ensuring it remains locked to the desired operating point on the microresonator's (205) resonance line. This improves sensitivity and stability, particularly when dealing with rapid changes in incident radiation or temperature fluctuations. Control algorithms can also be employed to optimize the coupling efficiency between waveguides and the microresonator, maximizing signal throughput. Another important role for algorithms is signal processing. Algorithms enhance the quality of the sensor output signal (228, 229) by reducing noise, improving signal-to-noise ratio, and compensating for drift or other unwanted effects. Digital filtering algorithms remove unwanted frequency components from the signal, while averaging algorithms reduce random noise fluctuations, improving measurement precision. Background subtraction algorithms remove constant or slowly varying background signals, enhancing the sensor's ability to detect small changes in the target IR signal (230). Temperature compensation algorithms correct for temperature-induced variations in sensor response, improving accuracy, and these algorithms often use data from the dark pixel (218) in dual-pixel sensor configurations. Algorithms also contribute to data analysis and interpretation. Algorithms can be implemented to convert the sensor output signal into meaningful physical quantities, including IR intensity, wavelength, or other parameters of interest. Algorithms enable calibration procedures, where the sensor output is correlated with known input signals or physical quantities, allowing quantitative measurements. Machine learning algorithms provide another approach to data analysis, enabling automated pattern recognition, classification, or prediction based on sensor data, which can be applied for tasks like identifying specific chemical species in spectroscopic applications, classifying different materials based on their thermal emission properties, or predicting system behavior based on real-time sensor readings. The algorithms can be implemented using various programming languages and software tools, such as MATLAB, Python, C++, and others depending on the complexity of the algorithm, the available computing resources, and other practical considerations. The algorithms' structure and complexity vary widely based on the specific functions performed. Simple control algorithms involve basic feedback loops and arithmetic operations. More advanced algorithms employ sophisticated signal processing techniques, digital filtering, or machine learning models, requiring higher processing power. The algorithms interact with the sensor hardware through data acquisition and control interfaces, typically implemented using analog-to-digital converters (ADCs) and digital-to-analog converters (DACs). Data from the photodiodes (228) is acquired by the computer through the ADCs, while control signals generated by the algorithms are converted to analog voltages or currents by the DACs and then routed to the appropriate sensor components, such as the tunable laser or integrated heaters.

Other elements can be used in the bolometer-optical microresonator infrared sensor and the associated detection process. Several additional features and configurations can enhance performance, versatility, and applicability. One such feature is the incorporation of integrated heaters on the island (204). These heaters can be used to actively control the temperature of the island, enabling temperature stabilization, calibration, or even modulation for specific applications. The heaters may be implemented using thin-film resistive elements fabricated from materials such as titanium nitride or platinum. They can be placed in close proximity to the microresonator (205) for efficient heat transfer. Control of the heaters may be integrated into the sensor control system, allowing automated temperature regulation and feedback loops. Another enhancement involves the integration of on-chip optical filters. These filters can be used to select specific wavelengths or bandwidths of infrared radiation, improving the sensor's selectivity and reducing interference from unwanted signals. Various filter designs, such as thin-film interference filters or photonic crystal filters, can be implemented using materials and processes compatible with the sensor fabrication. The sensor can also be integrated with on-chip signal processing circuitry. This circuitry can perform various signal processing functions, such as amplification, filtering, or analog-to-digital conversion, further enhancing performance and simplifying system integration. This circuitry can be implemented using standard CMOS technology, facilitating co-integration with other electronic components. The design of the absorber (206) can be tailored to specific application requirements. For broadband detection, the absorber can be a simple thin film of a material with high absorption across the target wavelength range. For narrowband detection, the absorber can be a frequency selective surface, such as a periodic array of metallic elements or a metamaterial structure, optimized for absorption at a specific wavelength or narrow bandwidth.

Alternative microresonator designs can be employed. While ring resonators are commonly used, other resonator geometries, such as racetrack resonators, photonic crystal cavities, or whispering gallery mode resonators of different shapes, can be used to tailor the optical properties, including resonance frequency and quality factor, to the specific application. The waveguide configuration can be adapted for various applications. For single-sensor applications, two waveguides, one for input and one for output, are sufficient. For sensor arrays, a single waveguide can be used to address multiple sensor elements via wavelength-division multiplexing. More complex waveguide networks can be implemented for advanced signal routing and processing functionalities.

Different materials can be used for the sensor components. While silicon nitride is often preferred for the legs and microresonator due to its low thermal conductivity and excellent optical properties, other materials such as silicon, silicon dioxide, or polymers, may be suitable depending on application requirements. The frame can be fabricated from silicon, glass, or ceramic. The absorber material may be chosen from various metals, such as gold, aluminum, or titanium, or from other materials, including carbon nanotubes or graphene. The sensor packaging can be adapted for specific applications. Vacuum packaging enhances thermal isolation, improving sensitivity. Hermetic sealing protects the sensor from environmental factors. Integrated windows or lenses can be incorporated into the package to allow incident radiation to reach the absorber while maintaining a controlled environment.

The dimensions of the sensor components, including the frame (201), legs (202, 203), island (204), microresonator (205), absorber (206), and waveguides (225), are design parameters that can be varied to optimize performance for different applications and wavelength ranges. The frame size influences the overall sensor footprint and can be adjusted to accommodate single elements or arrays of multiple elements. Frame dimensions may range from 100 μm to several millimeters. Leg length influences thermal isolation, with longer legs providing better isolation but potentially increasing susceptibility to mechanical vibrations. Leg lengths may range from tens of micrometers to several millimeters, specifically from 50 μm to 500 μm, and more specifically approximately 200 μm. Leg width affects both thermal conductance and mechanical strength. Narrower legs enhance thermal isolation but reduce robustness. Leg widths may range from 1 μm to 20 μm, specifically from 2 μm to 10 μm, and more specifically approximately 5 μm.

Island size accommodates the microresonator and absorber. Smaller islands improve thermal isolation and response time, while larger islands allow for more complex resonator designs or integration of multiple absorbers for different wavelength ranges. Island dimensions may range from tens of micrometers to hundreds of micrometers. Microresonator size influences its resonance frequency and quality factor. Smaller resonators typically exhibit higher resonance frequencies, while larger resonators can achieve higher quality factors. Ring resonators with radii ranging from 5 μm to 100 μm, specifically from 10 μm to 50 μm, and more specifically approximately 25 μm, can be employed. Absorber dimensions are chosen to optimize absorption efficiency at the target wavelengths. The absorber area should be sufficiently large to capture incident radiation effectively while minimizing any perturbation of the microresonator's optical properties. Absorber dimensions may range from tens of micrometers to hundreds of micrometers. Waveguide dimensions, such as width and height, determine the optical mode profile and propagation characteristics. Waveguide widths ranging from 0.5 μm to 5 μm, specifically from 0.75 μm to 2 μm, and more specifically approximately 1 μm can be implemented for single-mode operation at 1.55 μm.

The shapes and geometries of the sensor components are design choices that influence performance, fabrication, and integration. The frame (201), while typically rectangular or square, can be any shape compatible with the sensor layout and packaging requirements. Circular, elliptical, or other polygonal shapes may be employed. The frame geometry influences mechanical stability and integration with other components.

The legs (202, 203) are generally straight for simplicity and case of fabrication, but alternative geometries, such as curved, tapered, or branched legs, can be employed to optimize thermal isolation, mechanical properties, or integration with other on-chip structures. Curved legs, for example, might reduce stress concentrations, enhancing mechanical robustness, and tapered legs can optimize thermal gradients. Branched leg structures could provide additional mechanical support or facilitate integration of electrical interconnects.

The island (204) is typically square or rectangular, but its shape can be adapted to accommodate different microresonator (205) and absorber (206) designs. Circular, elliptical, or other shapes are possible. The island shape influences thermal distribution and coupling efficiency to the absorber and microresonator.

The microresonator (205) geometry affects its optical properties, such as resonance frequency, quality factor, and mode volume. While ring and racetrack resonators are common, other shapes, such as disk resonators, photonic crystal cavities, or whispering gallery mode resonators with more complex geometries, can be used to tailor optical performance to the application requirements. Different shapes may offer advantages in terms of quality factor, mode volume, or case of coupling to waveguides.

The absorber (206) shape can be adapted to optimize absorption efficiency and thermal coupling to the microresonator. Simple shapes like rectangles or squares are straightforward to fabricate. More complex shapes, such as fractal geometries or metamaterial absorbers, may improve absorption and enhance sensor performance. The absorber geometry should maximize absorption while efficiently transferring heat to the microresonator.

The waveguides (225) on the legs (203) are typically straight, but curved or bent waveguides may be necessary for routing optical signals or connecting to off-chip components. Waveguide bends should be designed with smooth curves and large radii to minimize bending losses, which would negatively affect signal transmission.

The waveguide transitions (208) are usually tapered to gradually match the mode profiles of the freestanding waveguides (203) to those of the substrate-supported waveguides (209), minimizing reflections and improving coupling efficiency. Other transition designs, such as adiabatic tapers or mode converters, may be employed depending on the specific waveguide geometries and refractive index contrast.

The edge couplers (213-216) may incorporate various geometries, such as gratings, tapers, or other diffractive structures, to efficiently couple light to and from optical fibers. The edge coupler design influences coupling efficiency, bandwidth, and alignment sensitivity.

The sensor packaging can also incorporate different shapes and geometries to optimize performance or integration. For example, the package may include a window or lens to focus incident radiation onto the absorber, enhancing signal collection.

In an embodiment, a process for fabricating a bolometer-optical microresonator infrared sensor comprises the steps of depositing a silicon nitride layer onto a silicon substrate; patterning the silicon nitride layer to define a microresonator, a waveguide coupler, legs, and a frame, the legs mechanically connecting the frame and an island where the microresonator and the waveguide coupler are located; depositing an absorber material onto the island; patterning the absorber material to form an absorber; depositing silicon dioxide (optionally) and silicon nitride layers onto the frame; patterning the silicon nitride layer to form substrate-supported waveguides and edge couplers; patterning a ridge into the patterned silicon nitride legs to form waveguides; and releasing the island by removing the underlying silicon substrate to form freestanding legs. In an embodiment, the process further comprises the step of forming a waveguide transition between the legs and the substrate-supported waveguides. In an embodiment, the step of depositing the silicon nitride layer comprises low-pressure chemical vapor deposition. In an embodiment, the step of patterning comprises electron beam lithography and dry etching. In an embodiment, the step of releasing the island comprises deep reactive ion etching and a wet KOH etch. In an embodiment, the absorber material comprises titanium and gold. In an embodiment, the microresonator is ring-shaped. In an embodiment, the step of depositing the silicon dioxide and silicon nitride comprises plasma-enhanced chemical vapor deposition. In an embodiment, each waveguide formed on the legs has a width less than 4 μm. In an embodiment, the process further comprises, wherein each of the steps of depositing and etching is performed under computer control, and at least one step comprises a calculating step performed by a computer implementing an algorithm to achieve an improved performance result.

The process can begin with depositing a silicon nitride layer (220) onto a silicon substrate (221). This layer serves as the foundation for many of the sensor's components. Low-pressure chemical vapor deposition (LPCVD) is one suitable method, offering precise control over film thickness and uniformity. Other techniques, such as plasma-enhanced chemical vapor deposition (PECVD), may be employed depending on the specific needs. This silicon nitride layer provides a high-quality material platform for subsequent fabrication steps. The thickness of this layer may range from 100 nm to 1 μm. The next step can include patterning the silicon nitride layer (220) using a combination of lithography and etching. This step defines the microresonator (205), waveguide coupler (207), legs (202, 203), and frame (201). Electron beam lithography offers high resolution, critical for defining the fine features of the microresonator and waveguides. Dry etching techniques provide precise control over feature dimensions, ensuring that the microresonator's optical properties are optimized, and the waveguide geometry is suitable for efficient light transmission. The patterning step must be executed with high precision and accuracy, minimizing edge roughness and variations in feature sizes, both critical for microresonator performance.

An absorber material (222) can then be deposited onto the island (204), forming the basis for the absorber (206). The absorber material can be a metal, such as gold or aluminum, or another material with high absorption in the target wavelength range, such as carbon nanotubes or graphene. Physical vapor deposition or sputtering are suitable deposition methods, offering good control over film thickness and uniformity. The thickness of the absorber material affects absorption efficiency, and this parameter should be tailored to the material characteristics and incident wavelength. The thickness of the absorber material may range from 10 nm to 1 μm. The absorber material (222) then can be patterned to define the final shape and size of the absorber (206). This step typically involves lithography and etching. The absorber design depends on the target wavelength range and desired absorption characteristics. For broadband detection, a simple rectangular shape is sufficient. For narrowband or wavelength-selective absorption, more complex geometries, such as a frequency selective surface comprising an array of metallic elements, can be employed.

Next, silicon nitride (224) and optionally silicon dioxide (223) layers are deposited onto the frame (201). These layers form the basis for the substrate-supported waveguides and edge couplers. PECVD is one suitable deposition technique for these materials, offering good control over film thickness, uniformity, and material properties. The thickness of these layers may range from 50 nm to 500 nm. The top silicon nitride layer (224) is then patterned to define the substrate-supported waveguides (209) and edge couplers (213-216). As with the first silicon nitride patterning step, lithography and dry etching are commonly used. The waveguide dimensions are chosen for single-mode operation at the desired wavelength near 1.55 μm, while the edge couplers are designed for efficient coupling to external optical fibers.

A ridge is then patterned into the legs (203) to form waveguides (225). This step transforms the legs into waveguiding structures. The ridge, which forms the waveguide core, is typically patterned using lithography and etching. The waveguide geometry is chosen to ensure low-loss single-mode operation at the desired wavelength (near 1.5 μm), maximizing light transmission efficiency to and from the microresonator. The ridge width may range from 0.5 μm to 2 μm.

Finally, the island (204) is released by removing the underlying silicon substrate (221). This step creates the freestanding legs (202, 203), providing thermal and mechanical isolation of the island from the frame. Deep reactive ion etching (DRIE) is commonly used to etch through the silicon substrate, followed by a wet KOH etch to remove any residual silicon. This process needs careful control to ensure complete release of the island without damaging other sensor components.

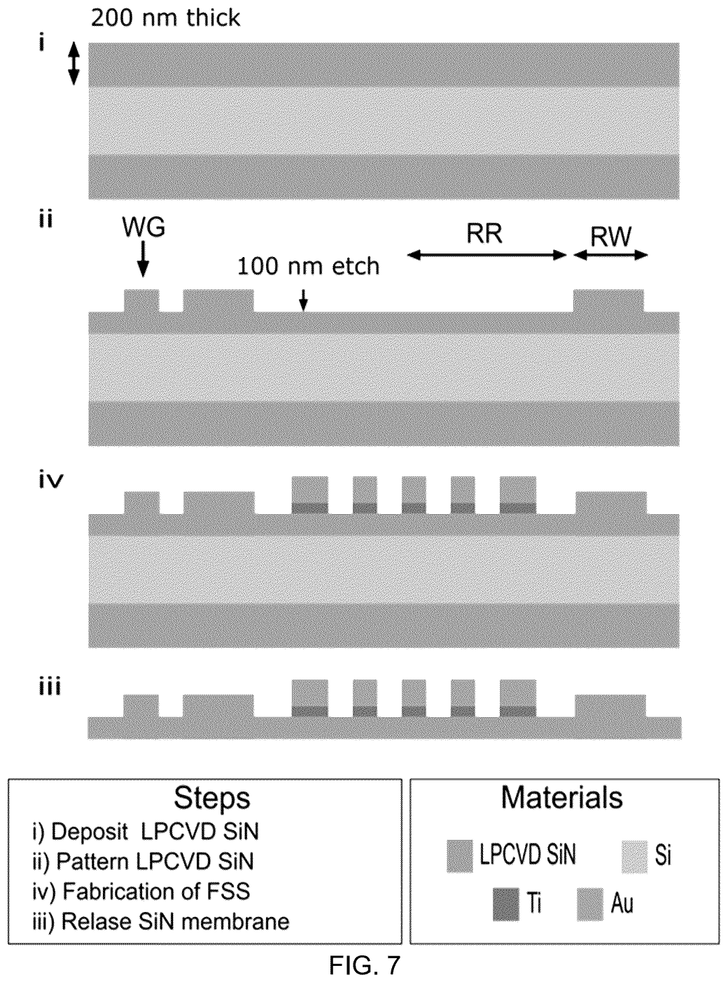

FIG. 7 depicts the fabrication steps for the island (204) of the bolometer-optical microresonator infrared sensor (200), highlighting the materials and processes involved. The fabrication begins with depositing a 200 nm thick layer of low-pressure chemical vapor deposition (LPCVD) silicon nitride (SiN) onto a silicon (Si) substrate. This SiN layer will form the structural basis for the island, including the microresonator (205), waveguide coupler (207), and freestanding legs (202, 203). The next step involves patterning the LPCVD SiN layer. This patterning step defines the microresonator, waveguide coupler, and legs, which will connect the island to the frame after release. The microresonator geometry is designed to achieve the desired optical properties, such as high quality factor and specific resonance frequencies. The waveguide coupler is positioned near the microresonator for efficient light coupling. The legs provide mechanical support and thermal isolation for the island. A partial etch of the SiN layer, e.g., 100 nm deep, creates a rib waveguide structure on the island for the microresonator and waveguides. This rib waveguide confines light, minimizing propagation losses, and thus enhances the quality factor. A frequency selective surface (FSS), implemented as a grid of metallic crosses, is then patterned onto the island, forming the absorber (206). The FSS design determines the absorber's spectral response, maximizing absorption at the desired wavelength or range of wavelengths. The FSS may be fabricated using a metal layer stack comprising titanium (Ti) and gold (Au). Titanium serves as an adhesion layer while gold provides high reflectivity, enhancing absorption. The final step is the release of the SiN membrane. This step removes the underlying Si substrate beneath the island, creating the freestanding structure supported by the legs. The release process typically involves a combination of dry and wet etching techniques. Deep reactive ion etching (DRIE) is used to etch through the Si substrate, followed by a wet KOH etch to remove any residual silicon and smooth the etched surfaces. This release step creates the thermally isolated island structure, maximizing the sensor's sensitivity to absorbed IR radiation. The fabrication process combines established microfabrication techniques, including deposition, lithography, etching, and metallization. The precise dimensions and materials used in each step can be varied to optimize performance, such as the silicon nitride thickness, absorber material, and FSS geometry. Alternative processes, materials, and dimensions can be used. For example, the silicon nitride layer can be deposited using PECVD instead of LPCVD. The lithography can be performed using DUV or EUV lithography for different feature size requirements. The etching process can employ alternative chemistries and techniques. The release process can use methods like XeF₂ etching or focused ion beam (FIB) milling. The absorber material and FSS can be implemented using different metals or materials like carbon nanotubes. The layer thicknesses and dimensions, such as waveguide width, ridge height, absorber size, FSS features, and island size, can be adjusted depending on design specifications.

In an embodiment, a process for detecting rapid changes in the intensity of infrared or far-infrared light comprises the steps of providing a bolometer-optical microresonator infrared sensor; providing a tunable continuous wave laser emitting light at a selected wavelength (e.g., near 1.55 μm); coupling light from the laser to an input waveguide of the sensor; tuning the laser such that an emission line of the laser lies on the blue wing of a resonance line of a microresonator; providing a photodiode at an output of an output waveguide of the sensor; exposing the sensor to infrared or far-infrared light whose intensity changes are to be measured; and detecting changes in light intensity at the output waveguide with the photodiode wherein the changes are indicative of changes in intensity of the infrared or far-infrared light. In an embodiment, tuning the laser comprises sweeping the laser's emission line across the microresonator's resonance line from higher frequency to lower frequency. In an embodiment, the sensor comprises at least two legs mechanically supporting an island relative to a frame, the microresonator being located on the island. In an embodiment, the process further comprises modulating the laser at a microwave frequency. In an embodiment, the modulating step imposes a sideband onto the laser's emission line. In an embodiment, the process further comprises locking the CW laser frequency to a resonance line of an external cavity. In an embodiment, the process further comprises providing a second bolometer-optical microresonator infrared sensor not exposed to the infrared or far-infrared light. In an embodiment, the process further comprises locking the CW laser frequency to a resonance line of the second sensor. In an embodiment, providing a photodiode comprises providing a temperature-stabilized photodiode. In an embodiment, the process further comprises performing at least one calculation step by a computer implementing an algorithm to achieve a useful technical effect including an amount of radiation absorbed by the absorber, a duty cycle of the radiation, a wavelength of the radiation, and the like.

The process for detecting rapid changes in the intensity of infrared or far-infrared light can begin by providing a bolometer-optical microresonator infrared sensor (200). This sensor integrates a microresonator (205) with a bolometric detection scheme, enabling sensitive and rapid measurements of changes in incident IR radiation. The sensor structure can include a frame (201), legs (202, 203) for supporting an island (204), the microresonator located on the island, an absorber (206) for capturing incident radiation, a waveguide coupler (207) for coupling light to and from the microresonator, waveguide transitions (208), substrate-supported waveguides (209), and edge couplers (213-216). The sensor's design includes thermal isolation of the sensing element, high quality factor of the microresonator, and efficient waveguide coupling. A tunable continuous wave laser (226) emitting light at a wavelength is then provided. This laser serves as the light source for probing the microresonator. The tunability of the laser allows its emission wavelength to be precisely adjusted to match a resonance of the microresonator. Continuous wave operation provides a stable optical signal, minimizing noise and enhancing detection sensitivity. The wavelength can correspond to the low-loss telecommunications band, enabling the use of readily available and cost-effective optical components, including the waveguides employed in the sensor. Light from the tunable laser (226) is coupled to an input waveguide (227) of the sensor (200). This step directs the laser light into the sensor's integrated waveguides. The input waveguide, typically a standard single-mode optical fiber, efficiently transmits the laser light to the sensor chip with minimal loss. Precise alignment of the input waveguide with the sensor's input edge coupler ensures efficient coupling of light into the on-chip waveguides. The laser (226) is tuned such that an emission line lies on the blue wing of a resonance line of the microresonator (205). The blue wing refers to the higher-frequency side of the resonance line, where the microresonator's response to changes in resonance frequency due to incident power is maximized. Operating on this wing ensures high sensitivity to changes in absorbed IR radiation and improves stability due to negative photothermal feedback. Precise tuning is achieved by adjusting the laser's wavelength while monitoring the transmitted light intensity.

A photodiode (228) is provided at the output of an output waveguide (229) of the sensor (200). This photodiode converts changes in light intensity exiting the sensor into an electrical signal that can be readily measured and analyzed. The photodiode is typically a high-speed, low-noise device with a spectral response matched to the laser's operating wavelength (near 1.55 μm). Temperature stabilization of the photodiode minimizes variations in its responsivity, enhancing measurement stability.

The sensor (200) is exposed to the infrared or far-infrared light (230) whose intensity changes are to be measured. This incident radiation is absorbed by the absorber (206), increasing the island's temperature and, consequently, the microresonator's temperature. This temperature change shifts the microresonator's resonance frequency, which modifies the transmitted light intensity. Changes in light intensity at the output waveguide (229) are detected with the photodiode (228). These changes in light intensity correspond to changes in the microresonator's resonance frequency caused by variations in absorbed IR radiation. The photodiode's output signal is then processed to determine the intensity changes in the incident IR light.

Sweeping the laser's (226) emission line across the microresonator's (205) resonance line from higher frequency to lower frequency ensures that the laser frequency is positioned on the desired operating point on the blue wing of the resonance. This technique allows the operator to identify the resonance peak and then precisely position the laser frequency on the blue wing for optimal sensor performance and stability. Alternative tuning methods, such as stepping the laser frequency in discrete increments or using a feedback loop to lock the laser to the resonance wing, are possible.

Modulating the laser (226) at a microwave frequency (231) creates sidebands on the laser's emission, which can probe the microresonator's resonance at multiple frequencies or can be used to address multiple resonators, each tuned to a slightly different frequency. This technique can enhance sensitivity, increase detection bandwidth, or enable simultaneous readout of multiple sensor elements. The microwave frequency can range from 1 GHz to 100 GHz, specifically from 10 GHz to 50 GHz, and more specifically approximately 20 GHz. The modulation depth and waveform can be adjusted to optimize the sideband characteristics.

Imposing a sideband on the laser's emission line through the modulation step enhances detection sensitivity and bandwidth. The sideband probes the microresonator's resonance at a frequency offset from the carrier, increasing the sensor's response to rapid changes in IR intensity.

Locking the CW laser frequency (232) to a resonance of an external cavity (233) improves the sensor's long-term stability by reducing noise and drift in the laser's emission frequency. This technique ensures that the laser frequency remains precisely positioned on the microresonator's resonance wing. The external cavity may be implemented using a high-finesse optical cavity or a stabilized fiber Bragg grating.

Providing a second bolometer-optical microresonator infrared sensor (218), shielded from incident radiation, establishes a reference or “dark” pixel for temperature compensation. This dark pixel's response reflects only ambient temperature changes, not the target IR signal. By comparing the bright and dark pixel signals, common-mode noise and drift due to temperature fluctuations can be effectively subtracted, enhancing measurement accuracy.

Locking the CW laser frequency (232) to a resonance line of the second sensor (218) further improves temperature stability by ensuring that both the bright and dark pixels experience the same laser frequency fluctuations. This technique enhances the effectiveness of the temperature compensation scheme.

Using a temperature-stabilized photodiode (228) minimizes variations in its responsivity due to temperature changes, further enhancing the sensor's stability and reducing measurement uncertainty. This technique reduces noise and improves the accuracy of the sensor output signal.

Employing a computer (234) to implement an algorithm (235) for signal processing, temperature compensation, or other functions, allows complex calculations and data processing, enhancing sensor performance and versatility. The computer may perform a variety of functions, including signal filtering, noise reduction, temperature compensation, or other signal processing operations.

Several additional steps and techniques can further enhance the performance, stability, and versatility of the sensor system. One such enhancement involves active stabilization of the laser (226) frequency (232). This can be achieved by locking the laser frequency to an external reference, such as a stable optical cavity (233) or an atomic transition line. This active stabilization minimizes frequency noise and drift, improving the sensor's long-term stability and reducing measurement uncertainty. Various locking techniques, such as the Pound-Drever-Hall technique or other feedback control methods, may be employed. Another refinement involves temperature stabilization of the sensor environment. Enclosing the sensor (200) in a temperature-controlled chamber minimizes temperature fluctuations, reducing drift and enhancing stability, particularly for high-precision measurements. The temperature setpoint and stability requirements depend on the sensor's thermo-optic coefficient and application needs. Temperatures may range from 20° C. to 30° C., specifically from 22° C. to 28° C., and more specifically approximately 25° C. Calibration of the sensor improves measurement accuracy. This may involve exposing the sensor to known infrared or far-infrared sources (230) and recording its response. Calibration data can be used to correct for nonlinearities or other variations in sensor response, and the calibration process may be repeated periodically to maintain measurement accuracy.

Signal processing techniques enhance the sensor's output signal. The photodiode signal (228) can be amplified, filtered, or processed using digital signal processing (DSP) techniques. These techniques reduce noise, improve signal-to-noise ratio, and enhance detection sensitivity. The specific signal processing methods used are tailored to the application requirements and the characteristics of the sensor's output signal. Algorithms implemented using a computer (234) or dedicated digital signal processor enable these techniques.

Wavelength modulation spectroscopy (WMS) techniques improve detection sensitivity and selectivity. By modulating the laser wavelength and detecting the resulting harmonics or other spectral features in the sensor's output signal, background noise and interference can be reduced. These techniques may be particularly useful for trace gas detection or other applications with low signal levels.

For enhanced stability and common-mode noise rejection, a dual-sensor configuration can be employed. One sensor is exposed to the incident radiation (bright pixel), while a second, identical sensor is shielded from the radiation (dark pixel). By taking the difference between the two sensor signals, common-mode noise and drift due to temperature fluctuations or other environmental factors are suppressed. This approach increases measurement accuracy and stability.

The use of balanced detection further improves noise rejection in dual-sensor configurations. The bright and dark pixel signals are subtracted electronically, canceling out common-mode noise and enhancing the differential signal. This balanced detection scheme can be implemented using a differential amplifier or other balanced detection circuitry.

Heterodyne detection techniques enhance sensitivity and frequency selectivity. By mixing the sensor output signal with a reference signal at a slightly different frequency, a beat frequency signal is generated. This beat frequency signal carries information about the changes in the sensor's output signal. This technique can improve signal-to-noise ratio and enable precise measurements of frequency shifts.

Optical chopping techniques modulate the incident IR radiation at a specific frequency. By synchronously detecting the sensor output signal at the chopping frequency, background noise and drift are reduced. This technique improves measurement accuracy and can be particularly useful in noisy environments.

Providing a bolometer-optical microresonator infrared sensor (200) establishes the core sensing element for the detection process. This sensor can include a microresonator (205) with a bolometric detection scheme. The sensor comprises a frame (201), legs (202, 203) supporting an island (204), the microresonator located on the island, an absorber (206), a waveguide coupler (207), waveguide transitions (208), substrate-supported waveguides (209), and edge couplers (213-216). The sensor's architecture is designed to achieve high sensitivity and speed by maximizing thermal isolation of the sensing element, employing a high-quality-factor microresonator, and ensuring efficient coupling of light through integrated waveguides. The sensor may be fabricated using various materials and processes, as described earlier, and its dimensions and geometry can be tailored to specific application requirements. The sensor chip is typically packaged in a vacuum or controlled environment to enhance thermal stability and minimize drift. Alternative sensor configurations, such as dual-sensor arrangements with bright and dark pixels for temperature compensation, may be employed depending on the application needs.

Providing a tunable continuous wave (CW) laser (226) emitting light at a selected wavelength (e.g., near 1.55 μm) establishes the optical source for probing the microresonator (205). The tunability of the laser allows precise adjustment of its emission wavelength to match a resonance of the microresonator. Continuous wave operation ensures a stable, narrow-linewidth optical signal, minimizing noise and maximizing detection sensitivity. The 1.55 μm wavelength corresponds to the low-loss telecommunications band, enabling use of readily available, cost-effective optical components such as single-mode optical fibers and other standard telecom equipment. Various types of tunable lasers, such as external cavity diode lasers (ECDLs), distributed feedback (DFB) lasers, or tunable fiber lasers, are suitable, offering different levels of tuning range, linewidth, and output power. The laser's output power is typically chosen to optimize sensor performance, balancing sensitivity with potential thermal effects on the microresonator. Output powers may range from 1 mW to 100 mW, specifically from 10 mW to 50 mW, and more specifically approximately 25 mW. Active stabilization of the laser frequency, by locking it to an external reference such as a stable optical cavity or an atomic transition, further enhances stability and reduces noise.

Coupling light from the tunable CW laser (226) to an input waveguide (227) of the sensor (200) directs the laser light into the sensor's integrated optical circuit. The input waveguide (227), typically a standard single-mode optical fiber operating at 1.55 μm, is carefully aligned with an input edge coupler (213, 214) on the sensor chip. The edge coupler efficiently transfers light from the fiber into the on-chip waveguide (209), minimizing coupling losses and maximizing the optical power delivered to the microresonator (205). Various coupling techniques, such as butt coupling, lens coupling, or grating coupling, can be employed, each having different requirements as to alignment precision and coupling efficiency. Precise alignment of the fiber and the edge coupler maximizes coupling efficiency and minimizes back reflections, improving sensor performance and stability. The coupling process can be performed manually or using automated alignment systems, depending on the required precision and throughput. Monitoring the transmitted light intensity during the coupling process verifies and optimizes the coupling efficiency.

Tuning the laser (226) positions its emission line on the blue wing of a resonance line of the microresonator (205). The blue wing corresponds to the higher-frequency side of the resonance. Positioning the laser on this wing maximizes the sensor's sensitivity to changes in the microresonator's resonance frequency induced by absorbed infrared radiation. Operating on the blue wing also enhances stability due to the inherent negative photothermal feedback, which reduces the sensor's susceptibility to noise and drift. The tuning process involves adjusting the laser's wavelength while monitoring the transmitted light intensity at the sensor's output. When the laser wavelength is swept across a resonance of the microresonator, a characteristic dip in the transmitted intensity will be seen, since, at the resonance frequency, light is absorbed by the microresonator. The laser is then tuned slightly off-resonance, positioning its emission line on the blue wing where the slope of the resonance curve is steepest. This operating point maximizes the sensor's response to changes in the microresonator's resonance frequency. Alternative tuning methods include using a feedback loop to actively lock the laser frequency to the desired point on the resonance wing, which reduces noise and improves long-term stability, or stepping the laser frequency in discrete increments until the desired operating point is found.

Providing a photodiode (228) at an output of an output waveguide (229) enables detection and measurement of the optical signal exiting the sensor (200). The photodiode converts variations in light intensity into a corresponding electrical signal. The output waveguide (229), typically a standard single-mode optical fiber, efficiently transmits light from the sensor chip's output edge coupler (215, 216) to the photodiode with minimal loss. The photodiode (228) is selected based on factors such as speed, sensitivity, and spectral response. High-speed photodiodes, such as InGaAs photodiodes, are preferred for applications requiring fast response times. The photodiode's spectral response should be matched to the laser's (226) operating wavelength near 1.55 μm for efficient detection. Temperature stabilization of the photodiode minimizes variations in its responsivity due to ambient temperature fluctuations, improving measurement accuracy and long-term stability. The photodiode signal is typically amplified and processed using electronic circuitry or a computer (234) implementing appropriate algorithms (235) for signal analysis and data acquisition. Although a photodiode is described herein, various photodetectors can be used, provided the bandwidth of such photodetector comports with the frequency response of resonator (205) due to absorption events by the absorber (206).

Exposing the sensor (200) to the infrared or far-infrared light (230) whose intensity changes are to be measured initiates the sensing process. The incident radiation is absorbed by the absorber (206) on the sensor's island (204). This absorption causes a temperature change on the island, which in turn affects the microresonator's (205) properties. The absorber material and geometry are chosen to maximize absorption in the desired wavelength range. The amount of temperature change depends on the intensity of the incident radiation, the absorption coefficient of the absorber material, and the thermal properties of the island and supporting legs (202, 203). The sensor's response time is dictated by the thermal time constant of the island, which is influenced by the thermal conductivity and heat capacity of the island material, the length and width of the legs, and other factors. Shorter legs and lower thermal conductivity materials produce faster response times, allowing the sensor to detect rapid changes in IR intensity. The temperature change on the island induces a shift in the microresonator's resonance frequency, modulating the intensity of light transmitted through the waveguides and ultimately detected by the photodiode (228).

Detecting changes in light intensity at the output waveguide (229) with the photodiode (228) converts the sensor's optical response into a measurable electrical signal. Changes in the intensity of light transmitted through the microresonator (205), induced by variations in absorbed IR radiation (230), are detected by the photodiode. The photodiode output signal, which is proportional to the light intensity, is then amplified and processed to determine the corresponding changes in IR intensity. The speed and sensitivity of the detection process are determined by the characteristics of the photodiode, such as its bandwidth and responsivity, as well as by the noise level of the detection circuit. The detected signal can be further processed using digital signal processing (DSP) techniques, such as filtering, averaging, or other signal processing algorithms, to enhance the signal-to-noise ratio and improve measurement accuracy. These algorithms may be implemented using a computer (234) or a dedicated DSP chip. The processed signal then provides a quantitative measure of the changes in intensity of the incident infrared or far-infrared light. Calibration of the sensor, by exposing it to known IR sources and recording its response, improves measurement accuracy and enables quantitative measurements of IR intensity.

The operating conditions and parameters of the bolometer-optical microresonator infrared sensor (200) and the associated detection process can be adjusted to optimize performance for various applications and operating environments. The laser (226) wavelength, power, and linewidth influence the sensor's sensitivity, resolution, and stability. While a wavelength near 1.55 μm is often preferred due to the availability of low-loss waveguides and other components in the telecommunications band, other wavelengths may be employed depending on the microresonator material and the target IR wavelength range. Laser wavelengths can range from the visible to the mid-infrared region of the spectrum (400 nm-5 μm), with specific values chosen based on the application needs and available components. The laser power affects the strength of the photothermal feedback and thus the sensor bandwidth. Higher laser powers generally increase bandwidth but may also introduce thermal noise or instability. Laser power can range from microwatts to milliwatts, specifically from 100 μW to 10 mW, and more specifically approximately 1 mW, carefully chosen to balance sensitivity and bandwidth requirements while minimizing adverse effects on the microresonator. Narrower laser linewidths reduce noise and improve spectral resolution, important for spectroscopic applications.

The coupling efficiency between the input waveguide (227) and the sensor (200) influences the amount of light delivered to the microresonator (205). Higher coupling efficiencies maximize signal strength and reduce noise, while lower coupling efficiencies are sometimes useful when studying specific properties of the microresonator such as photothermal feedback. Careful alignment of the waveguide with the edge coupler (213, 214) and use of appropriate coupling techniques, such as butt coupling, lens coupling, or grating coupling, maximize efficiency. Coupling efficiencies may range from 10% to 90%, specifically from 30% to 70%, and more specifically approximately 50%, chosen to balance signal strength with other design considerations.

The sensor's operating temperature affects its performance and stability. Higher temperatures generally increase thermal noise but can also improve response time. Lower temperatures reduce thermal noise but may also slow down response. Temperature stabilization, either passively through thermal insulation or actively through temperature control systems, enhances stability and minimizes drift. Operating temperatures may range from cryogenic temperatures up to room temperature, with specific values chosen based on the microresonator material's properties and performance requirements.

The photodiode's (228) responsivity, bandwidth, and noise characteristics influence the sensitivity and speed of the detection process. Higher responsivity photodiodes produce larger electrical signals for a given change in light intensity, while higher bandwidth photodiodes enable detection of faster changes in IR intensity. Lower noise photodiodes enhance sensitivity by reducing the minimum detectable signal change.

The signal processing techniques employed affect the sensor output. Amplification increases signal strength, and filtering removes unwanted noise or interference. Averaging enhances measurement precision, while background subtraction can remove unwanted signals or drift. Digital signal processing algorithms implemented by a computer (234) or dedicated DSP enable complex signal processing functions for noise reduction, temperature compensation, and other advanced functionalities.

The integration of optical filters or spectrometers into the detection process enhances wavelength selectivity, enabling applications such as chemical sensing or spectroscopy. The filter or spectrometer characteristics, including bandwidth, center wavelength, and spectral resolution, determine the sensor's ability to isolate specific wavelengths. The sensor's operating environment influences its performance and stability. Factors such as ambient temperature, humidity, and pressure affect the sensor's response and can introduce noise or drift. Packaging the sensor in a controlled environment, such as a vacuum chamber or a hermetically sealed package, enhances stability and reduces susceptibility to environmental variations.

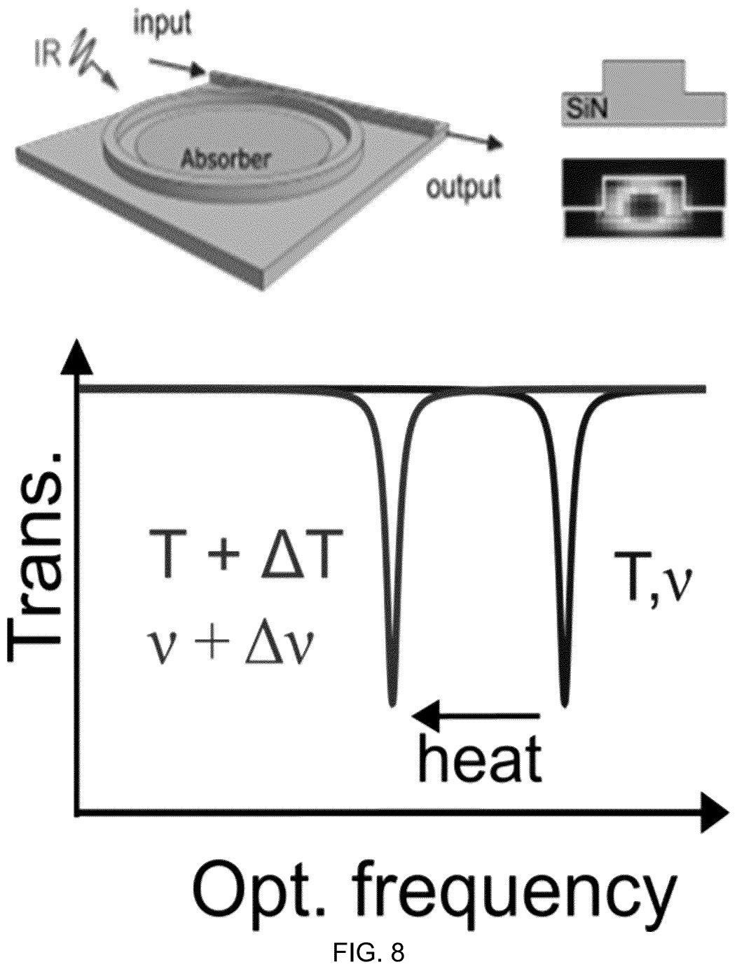

FIG. 8 illustrates the operating principle of the bolometer-optical microresonator infrared sensor (200), emphasizing the photothermal transduction mechanism. The sensor structure, shown in a simplified perspective view with thermal isolation features not shown, includes an absorber, a microresonator, and an output waveguide. Incident infrared (IR) radiation is absorbed by the absorber, raising its temperature. This temperature increase is conducted to the microresonator, which is thermally coupled to the absorber. The microresonator, typically a ring resonator made of a material with a temperature-dependent refractive index, such as silicon nitride, experiences a change in its refractive index due to the temperature rise. This refractive index change shifts the microresonator's resonance frequency. The microresonator's optical properties are probed using light from an external source, typically a tunable laser (226), coupled to an input waveguide (not shown in the figure). Changes in the microresonator's resonance frequency affect the intensity of light transmitted through the output waveguide. A photodiode (228), connected to the output waveguide, detects these intensity changes, converting the optical signal into a measurable electrical signal. The figure also includes a schematic representation of the microresonator's optical mode, highlighting the light confinement within the resonator structure. This light confinement enhances light-matter interaction, improving sensitivity to changes in refractive index caused by temperature variations. The graph in the lower part of FIG. 8 illustrates the shift in the microresonator's resonance frequency due to the temperature increase caused by absorbed IR radiation. The blue curve represents the microresonator's transmission spectrum at an initial temperature T, while the red curve shows the shifted spectrum at an elevated temperature T+ΔT. The resonance frequency shift, Av, is proportional to the temperature change and the microresonator material's thermo-optic coefficient. The thermo-optic coefficient, a material property, describes the change in refractive index with temperature. The sensor's sensitivity is enhanced by using materials with large thermo-optic coefficients and designing the sensor structure to maximize thermal isolation of the microresonator and absorber, thus increasing the temperature change for a given incident power. Precise tuning of the probe laser frequency to the microresonator's resonance maximizes the sensor's response to small changes in resonance frequency. Operating on the blue wing of the resonance, the higher frequency side, ensures stability due to the photothermal feedback mechanism. The magnitude of the resonance frequency shift, and hence the sensor's output signal, is proportional to the absorbed IR power. Calibration of the sensor using known IR sources allows for quantitative measurements.

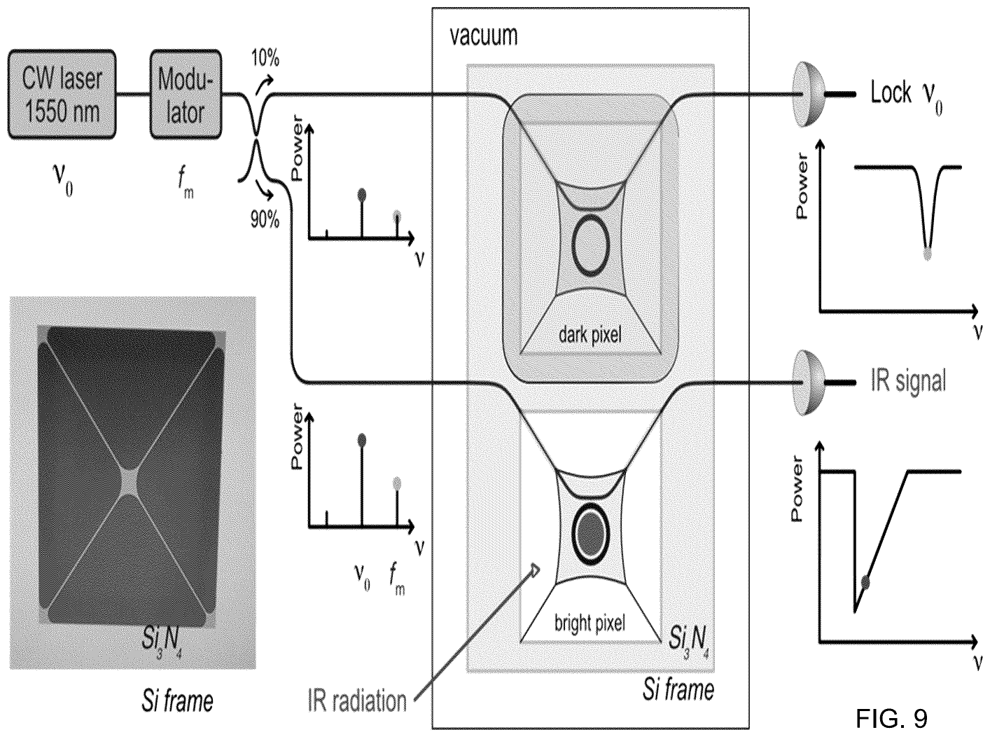

FIG. 9 presents a schematic of a dual-pixel sensor system incorporating a bright pixel (217) and a dark pixel (218) for enhanced stability and noise reduction. The system includes a continuous wave (CW) laser (226) operating at a wavelength of 1550 nm, a modulator, optical splitters, the sensor pixels, and photodiodes for signal detection. The CW laser provides a stable, narrow-linewidth light source at the main laser frequency, v₀. The modulator imposes a frequency shift, fₘ, onto a portion of the light creating a sideband. This light is split using an optical splitter, shown as having a 90/10 splitting ratio. The lower optical path, carrying 90% of the power, is directed to the bright pixel (217) waveguide input edge coupler (213), while the lower optical path, carrying 10% of the power, is routed to the dark pixel (218) waveguide input edge coupler (214). This arrangement leverages the sensor's photothermal feedback mechanism. The bright pixel, exposed to the incident IR radiation (230) absorbs power, thus shifting its resonance frequency and modulating the transmitted light intensity at frequency v₀, as described above. The dark pixel, shielded from incident radiation, serves as a reference, its response reflecting ambient temperature changes and other environmental factors. The dark pixel's resonance remains relatively unperturbed. The modulated output light from the bright pixel is routed to a photodiode, and the dark pixel's output is sent to a lock loop circuit. The lock loop circuit compares the dark pixel output signal to a reference signal at frequency v and adjusts the CW laser frequency to maintain the dark pixel resonance at a fixed frequency v. This feedback loop compensates for ambient temperature fluctuations, reducing drift and improving long-term stability. The bright pixel signal provides the actual measurement of rapid IR intensity changes, its stability improved by the dark pixel feedback loop. The system operates under vacuum, minimizing thermal noise. The frequency-shifted sideband used for the dark pixel lock ensures that the main laser frequency is not affected by the feedback loop. The graphs on the right-hand side of FIG. 9 show representative signal profiles. The upper graph depicts the lock loop signal, while the lower graph illustrates the bright pixel IR signal. The horizontal axis represents optical frequency, and the vertical axis corresponds to signal power. The lock loop signal shows a dip at the frequency of the dark pixel resonance, which is maintained at a fixed point by the feedback loop. The bright pixel IR signal shows changes in intensity corresponding to changes in incident IR radiation, superimposed on the main laser frequency.

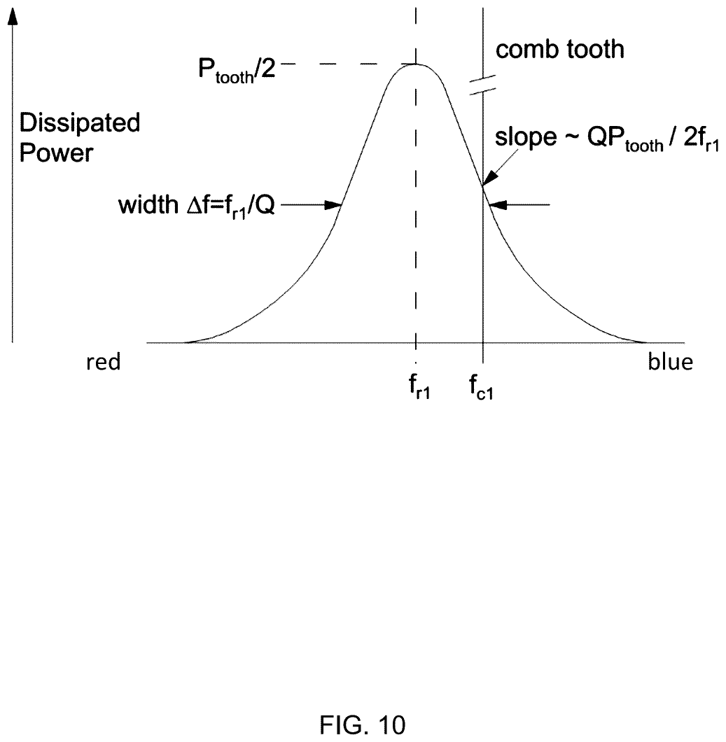

FIG. 10 shows photothermal feedback mechanism in the bolometer-optical microresonator infrared sensor, focusing on the interaction between a single resonance of the microresonator and a single tooth of a frequency comb. The graph shows the dissipated power in the microresonator as a function of frequency. The microresonator's resonance is represented by a Lorentzian curve centered at frequency fᵣ₁. A frequency comb, generated by modulating a continuous-wave laser, comprises a series of evenly spaced frequency lines, or teeth. One such tooth, positioned near the microresonator's resonance, is shown in the figure. The frequency of the comb tooth, f_{c1}, is chosen to lie on the wing of the resonance, either the red wing (lower frequency side) or the blue wing (higher frequency side), where the slope of the resonance curve is steepest. The amount of power dissipated in the microresonator by the comb tooth depends on the frequency difference between the tooth and the resonance, as shown by the intersection points on the graph. When incident IR radiation is absorbed, it increases the temperature of the microresonator, causing its resonance frequency to shift due to the thermo-optic effect. This shift in resonance frequency, in turn, alters the amount of power dissipated in the microresonator by the comb tooth, since the tooth is locked to a fixed frequency. If the comb tooth is positioned on the blue wing of the resonance, a temperature increase causes the resonance to shift to lower frequencies, moving away from the tooth. This reduces the dissipated power, producing negative photothermal feedback, since the temperature rise reduces the power dissipated by the probe laser. Conversely, if the comb tooth is on the red wing, a temperature increase causes the resonance to shift closer to the tooth, thereby increasing dissipated power and creating positive photothermal feedback. This feedback mechanism, resulting from the interaction between the microresonator's temperature-dependent resonance and the fixed-frequency comb tooth, enhances the sensor's bandwidth. The strength of the feedback can be controlled by adjusting the laser power and the coupling efficiency between the waveguide and the microresonator. The graph in FIG. 10 also shows the linewidth of the microresonator resonance, Δf/Q, determined by the resonance frequency and the quality factor Q. Higher Q values result in narrower linewidths and thus sharper resonances, increasing sensitivity to frequency shifts. The figure indicates that the slope of the resonance curve near the comb tooth is proportional to Q and the power of the comb tooth. This slope determines the strength of the photothermal feedback, since the frequency shift corresponding to a temperature change translates to a change in dissipated power via this slope. The sign of the slope, and therefore the feedback, depends on which wing of the resonance the comb tooth is on. A positive slope indicates positive feedback, and a negative slope indicates negative feedback. Negative feedback enhances sensor stability because temperature increases reduce dissipated power, minimizing thermal runaway or instability.

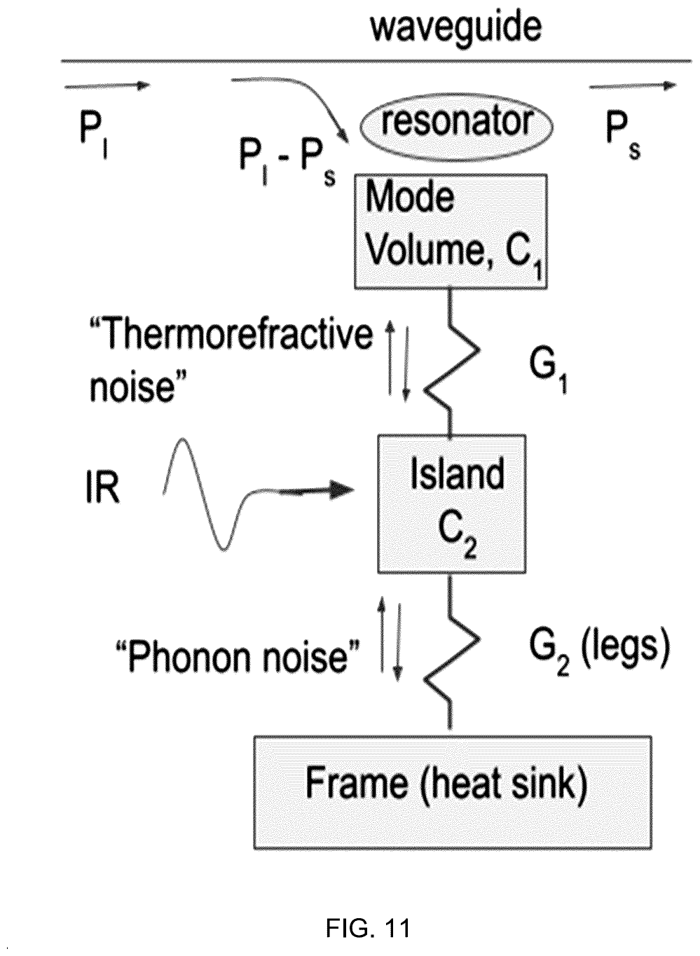

FIG. 11 illustrates the thermal model of the bolometer-optical microresonator infrared sensor, using a two-reservoir thermal circuit. This model represents the sensor's thermal behavior, enabling analysis of its sensitivity, speed, and stability. The circuit comprises two thermal reservoirs, representing the microresonator's mode volume and the sensor island, connected by thermal conductances and subject to incident power and thermal noise sources. The mode volume reservoir represents the region of the microresonator where the optical mode is confined. It has a heat capacity, C₁, and is connected to the island reservoir through a thermal conductance, G₁. This conductance represents the thermal resistance between the mode volume and the rest of the island. The island reservoir represents the entire sensor island, including the absorber and the microresonator. It has a heat capacity, C₂ and is connected to the surrounding frame (acting as a heat sink) through a thermal conductance, G₂. This conductance reflects the thermal resistance of the legs that support the island. Incident IR radiation, represented by a wavy arrow labeled “IR,” is absorbed by the absorber on the island and introduces heat into the island reservoir. This heat flow can be indicated as PIR and represents the absorbed IR power. Thermal fluctuation noise, inherent in any thermal system, is represented by double arrows adjacent to the thermal conductances G₁ and G₂. These noise sources, labeled “Thermorefractive noise” and “Phonon noise,” respectively, introduce random temperature fluctuations into the system and limit the sensor's ultimate sensitivity. The sensor's waveguide is also depicted, guiding light to and from the microresonator. Incident light from the waveguide, Pᵢ, is coupled into the microresonator. A portion of this light, Pₛ, is transmitted through the microresonator and out through the waveguide. The difference, Pᵢ−Pₛ, represents the light power stored by the microresonator due to waveguide coupling. This two-reservoir model captures the essential thermal dynamics of the sensor, including the thermal isolation of the island, the thermal coupling between the absorber and the microresonator, and the photothermal feedback mechanism. The model parameters, including the heat capacities, thermal conductances, absorbed IR power, and noise sources, determine the sensor's performance characteristics, including sensitivity, speed, and stability. The ratio G₁/G₂ determines the thermal isolation and therefore the sensitivity. Lower G₂ values, while enhancing sensitivity, correspond to longer legs, which would result in reduced mechanical stability. The ratio C₂/G₂ can determine the thermal response time, influencing sensor bandwidth. Higher heat capacity or lower thermal conductance increases response time, thus lowering the bandwidth. Analysis of this thermal circuit enables optimization of the sensor design to maximize sensitivity, speed, and stability for various applications.

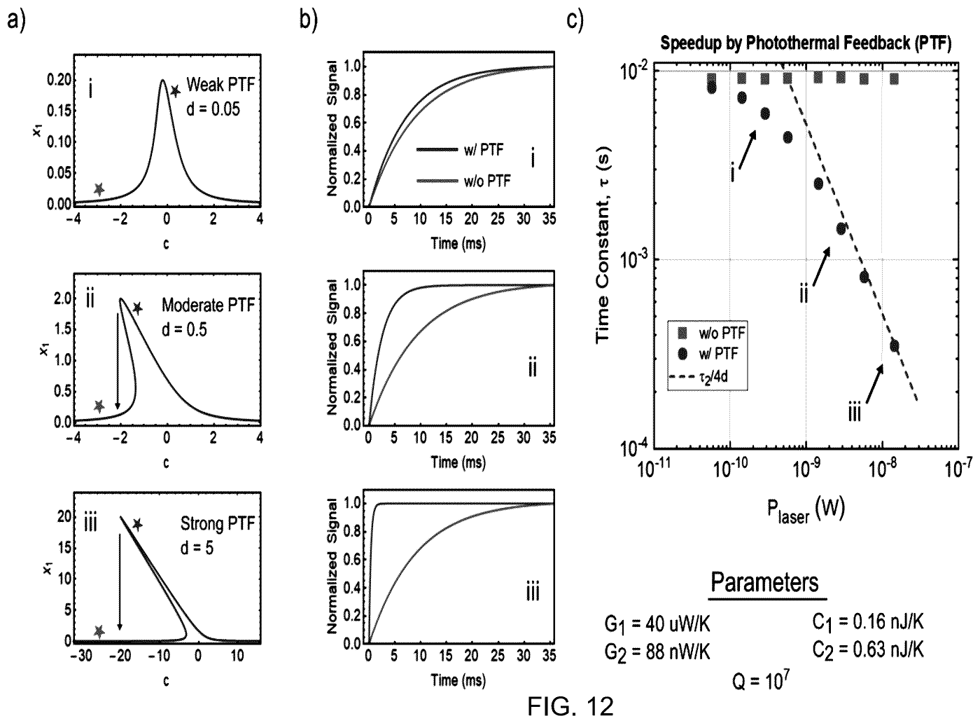

FIG. 12 illustrates the impact of photothermal feedback (PTF) on the bolometer-optical microresonator infrared sensor's performance, demonstrating its ability to enhance speed without sacrificing sensitivity. The figure comprises three subfigures: (a) shows laser-microresonator tuning curves for different PTF strengths; (b) depicts temporal responses to a step increase in IR power; and (c) plots the effective bolometer time constant as a function of laser power. FIG. 12 (a) presents tuning curves, representing the normalized microresonator temperature x₁ as a function of the normalized laser detuning c. The curves are plotted for three different values of d, a dimensionless parameter representing normalized laser power, corresponding to weak (i), moderate (ii), and strong (iii) PTF. For weak PTF (d=0.05), the tuning curve is approximately Lorentzian, typical for a microresonator. As the PTF strength increases (d=0.5 and d=5), the tuning curves become asymmetric and exhibit hysteresis. This hysteresis, a characteristic of photothermal feedback, arises from the temperature dependence of the microresonator's resonance frequency and the resulting feedback loop. Red and blue stars on the tuning curves mark the operating bias points for the temporal response measurements shown in FIG. 12 (b). The red stars correspond to operation on the red wing (lower frequency side) of the resonance, where PTF is positive, and the blue stars indicate operation on the blue wing (higher frequency side), where PTF is negative. FIG. 12 (b) presents the sensor's normalized temporal response to a step increase in incident IR power, for the same three PTF strengths. The response is plotted as normalized signal versus time. For weak PTF (i), the response is slow, with a long time constant since it is determined primarily by the thermal properties of the sensor island. As PTF strength increases (ii and iii), the response becomes significantly faster due to the feedback mechanism. This speedup is particularly pronounced for operation on the blue wing (blue curves), where negative feedback enhances response time. FIG. 12 (c) summarizes the effect of PTF on the sensor's effective time constant, t, plotted as a function of laser power, Plaser, for both blue detuning (with PTF) and red detuning (without PTF). The blue data points (circles) show that the time constant decreases significantly with increasing laser power for blue detuning, demonstrating the bandwidth enhancement provided by negative PTF. The red data points (squares) show little change in time constant with laser power for red detuning, indicating that PTF plays a minor role on this side of the resonance. The dashed blue line represents the theoretical limit of the time constant, τ=τ₂/4d, which is approached at high laser powers. The parameters used for the calculations, including thermal conductances G₁ and G₂, and heat capacities C₁ and C₂, are listed below the graph. These parameters correspond to realistic values for microfabricated sensors.

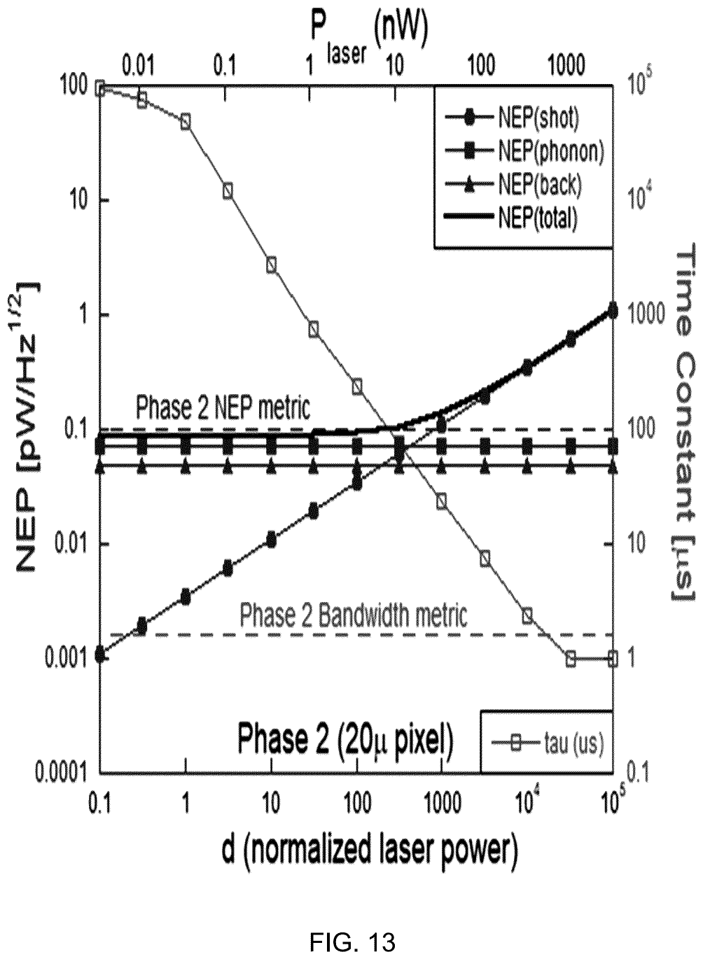

FIG. 13 shows a graph of performance of a phase 2 bolometer-optical microresonator infrared sensor (OMBolo), a more aggressively designed device with a smaller pixel size (20 μm). This more aggressive design is intended to achieve the goals of increased sensitivity and speed for demanding applications. The graph plots both noise-equivalent power (NEP) and time constant (τ) as functions of normalized laser power (d), allowing a direct comparison of sensitivity and speed for different operating conditions. The NEP, measured in picowatts per square root of Hertz (pW/Hz^{1/2}), quantifies the minimum detectable signal power. Lower NEP values indicate better sensitivity. The time constant t, measured in microseconds (μs), characterizes the sensor's response time to changes in IR intensity. Smaller time constants correspond to higher bandwidths, allowing faster detection of intensity changes. The graph shows NEP and t plotted on the left and right vertical axes, respectively, both as functions of normalized laser power, d, on the horizontal axis. The horizontal top axis shows laser power Plaser in nanowatts (nW), for comparison. The graph includes curves for NEP (shot), NEP (phonon), NEP (back), and NEP (total), representing the different noise contributions to the sensor's overall NEP. NEP (shot) arises from shot noise in the photodetector current, a fundamental noise source in optical detection systems, which changes with increasing laser power. NEP (phonon) is caused by thermal fluctuation noise in the sensor's legs, another fundamental noise source related to thermal conductance, which is independent of laser power. NEP (back) corresponds to background radiation noise, also independent of laser power, which depends on the ambient IR environment. NEP (total) represents the sum of all noise contributions and determines the sensor's overall sensitivity. The graph also shows the Phase 2 NEP metric (near 0.1 pW/Hz^{1/2}) and the Phase 2 bandwidth metric (near 1 μs) as horizontal lines for comparison with the calculated performance. The NEP (total) curve is nearly constant at low laser powers, reflecting the dominant role of phonon and background noise. As laser power increases, shot noise becomes the primary noise source. The time constant decreases rapidly with increasing laser power, due to the enhanced photothermal feedback at higher laser power. This speedup comes at the cost of increased shot noise, as seen in the rising NEP (shot) curve. The optimal operating point, indicated by the intersection of the NEP (total) curve and the Phase 2 NEP metric line, balances these noise contributions to achieve a high sensitivity within the required bandwidth. The time constant at this operating point lies above the Phase 2 bandwidth metric, demonstrating that the sensor can achieve the target sensitivity and speed simultaneously. The graph shows that by carefully adjusting the normalized laser power (or laser power), the sensor's performance can be optimized for specific application requirements, trading bandwidth for sensitivity, or vice versa. The 20 μm pixel size results in a reduced thermal time constant of the island, enabling higher bandwidth operation, and thus the sensor demonstrates improved performance compared to larger pixels.

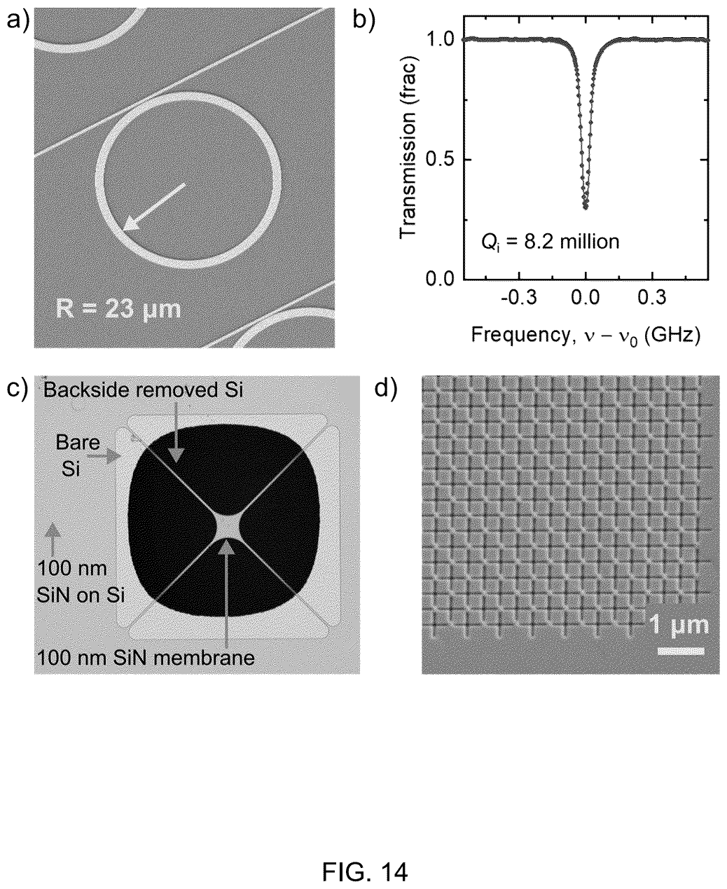

FIG. 14 shows experimental data and images relevant to the bolometer-optical microresonator infrared sensor, including high-Q silicon nitride (SiN) microresonators, suspended SiN membranes, and fabricated frequency selective surfaces (FSS). These components achieve the sensor's high performance, and the demonstrated fabrication capabilities validate the feasibility of the sensor architecture. FIG. 14(a) shows a scanning electron microscope (SEM) image of a fabricated SiN microresonator. The microresonator is a ring-shaped structure with a radius, R, of 23 μm. The ring is formed from a SiN waveguide, and the light contrast indicates the SiN material. The darker contrast represents the underlying substrate. The arrow points to the waveguide, highlighting its ring shape and length of its radius. The microresonator supports whispering gallery modes, enhancing light-matter interaction and providing a sensitive transduction mechanism for the sensor. FIG. 14(b) displays the measured optical transmission spectrum of a SiN microresonator, demonstrating its high quality factor. The graph plots transmission (normalized to unity) as a function of frequency detuning from the resonance frequency, v−v₀, measured in gigahertz (GHz). The sharp resonance dip indicates a high quality factor, Q, which enhances sensitivity. The blue data points represent the measured transmission, and the red dashed curve shows a fitted Lorentzian lineshape. The fitted quality factor for this particular microresonator is 8.2 million, demonstrating the ability to fabricate high-Q SiN microresonators using standard microfabrication processes. This high Q value translates directly to enhanced sensor sensitivity. FIG. 14(c) shows an optical image of a fabricated suspended SiN membrane, a key element for achieving thermal isolation in the sensor. The membrane, a square structure, is supported by four thin tethers connected to the surrounding Si frame. The membrane and tethers are made from 100 nm thick SiN. The central darker region indicates the area where the underlying Si substrate has been removed, leaving the freestanding membrane structure. The labels indicate the different layers present, including the bare Si substrate, the SiN on Si layer, and the 100 nm SiN membrane. The tethers' dimensions (length and width) and the membrane size determine thermal conductance from the membrane to the frame and thus thermal isolation of the membrane. FIG. 14(d) displays an SEM image of a fabricated frequency selective surface (FSS) formed from crossed slots in a titanium/gold (Ti/Au) layer stack. The FSS, used for the absorber (206) in the sensor, consists of a periodic array of crossed slots, the light gray regions corresponding to the metal and the dark regions to the slots. The scale bar indicates a length of 1 μm, showing the periodicity of the FSS structure. The FSS design determines the absorber's spectral response, and the choice of materials and geometry can be tailored for various wavelength ranges. The demonstrated fabrication of FSS structures on SiN membranes highlights the capability to create complex, integrated sensor elements.

The bolometer-optical microresonator infrared sensor (200) distinguishes itself from existing technologies through its unique combination of bolometric detection, optical microresonators, and integrated waveguide architecture. Traditional bolometers, while offering reasonable sensitivity, are limited in speed due to the thermal nature of their detection mechanism. This sensor (200), however, leverages the high quality factor and rapid optical response of the microresonator (205) to achieve both high sensitivity and high speed. Unlike antenna-coupled detectors, which often suffer from low sensitivity, this sensor's architecture enhances sensitivity through thermal isolation and optimized waveguide coupling. Furthermore, unlike semiconductor-based photodetectors requiring cryogenic cooling, this sensor operates at room temperature, simplifying system design and reducing cost.

The sensor's (200) integrated waveguide architecture, including the freestanding waveguide support legs (203), waveguide transitions (208), substrate-supported waveguides (209), and edge couplers (213, 215), provides a low-loss path for optical signals, enhancing sensitivity and enabling multiplexed readout of sensor arrays. This integrated design simplifies fabrication, reduces device footprint, and improves scalability compared to systems employing separate, discrete waveguides. The use of all-dielectric legs for both mechanical support and optical signal transmission further enhances thermal isolation, increasing sensitivity. Conventional microbolometer arrays rely on metallic interconnects for readout, which compromises thermal isolation. This all-dielectric design maximizes thermal isolation, leading to improved performance.

The incorporation of photothermal feedback, inherent in the coupling of the microresonator (205) to the waveguide coupler (207), distinguishes this sensor from other microresonator-based sensors. This feedback mechanism enhances bandwidth by effectively increasing the sensor's response rate to changes in incident power. Furthermore, operating on the blue wing of the microresonator's resonance provides inherent stability due to the negative feedback effect, eliminating the need for complex active stabilization schemes, simplifying system design. This self-stabilizing behavior, a direct result of photothermal feedback, makes the sensor more robust and less susceptible to noise and drift. This allows use of a modulated optical carrier, where each sideband probes the resonance frequency of a separate microresonator, enabling multiplexed readout from a large array of pixels. Each pixel's microresonator is tuned to a slightly different optical wavelength, and those wavelengths are chosen to correspond to sideband frequencies of the modulated laser. This arrangement significantly simplifies the readout process while enabling increased bandwidth and sensitivity. The elimination of electrical interconnects to each pixel, together with vacuum packaging of the array, enables exceptionally low values of thermal conductance G between each pixel and its surroundings—as much as three orders of magnitude lower than in current microbolometer arrays. This extreme thermal isolation increases temperature sensitivity by maximizing the temperature change for a given input power, enhancing sensitivity. The sensor architecture further provides flexibility in optimizing performance by adjusting the laser power and coupling efficiency to balance sensitivity and bandwidth requirements for specific applications. The dual-pixel configuration, with a bright pixel (217) exposed to incident radiation and a dark pixel (218) shielded by a radiation shield (219), enhances stability and enables compensation for ambient temperature fluctuations, further improving measurement accuracy. The sensor's ability to operate at room temperature, combined with its small size and compatibility with standard microfabrication techniques, offers significant advantages in terms of cost, complexity, and portability. This combination of features makes the sensor well-suited for a range of applications, including thermal imaging, spectroscopy, and remote sensing, where high sensitivity, speed, and stability are required.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

### PARTS LIST

bolometer-optical microresonator infrared sensor 200
frame 201
non-waveguide support leg 202
freestanding waveguide support leg 203
island 204
microresonator 205
absorber 206
waveguide coupler 207
waveguide transition 208
substrate-supported waveguide 209
waveguide leg width 210
ridge width 211
waveguide leg length 212
bright pixel waveguide input edge coupler 213
dark pixel waveguide input edge coupler 214
bright pixel waveguide output edge coupler 215
dark pixel waveguide output edge coupler 216
bright pixel 217
dark pixel 218
radiation shield 219
silicon nitride layer 220
silicon substrate 221
absorber material 222
silicon dioxide 223
silicon nitride 224
waveguide 225
tunable continuous wave laser 226
input waveguide 227
photodiode 228
output waveguide 229
infrared or far-infrared light 230
microwave frequency 231
CW laser frequency 232
external cavity 233
computer 234
algorithm 235

What is claimed is:

1. A bolometer-optical microresonator infrared sensor (200) comprising:
a frame (201);
at least two legs (203) mechanically supporting an island (204) to the frame (201), wherein a ridge is patterned into each leg (203) forming a waveguide;
a microresonator (205) located on the island (204) comprising a closed loop ridge waveguide;
an absorber (206) on the island (204) separated from the microresonator (205);
a waveguide coupler (207) on the island (204) for connecting a waveguide on each leg (203) to the microresonator (205);
a waveguide transition (208) on the frame (201) located at an end of each leg (203) for transmitting light between the waveguide on the leg (203) and a waveguide (209) supported by a substrate; and
an edge coupler (213, 215) at an end of the substrate-supported waveguide (209).

2. The sensor (200) of claim 1, further comprising at least one non-waveguide support leg (202) mechanically attached to the island (204) and the frame (201).

3. The sensor (200) of claim 1, wherein the frame (201) is silicon.

4. The sensor (200) of claim 1, wherein each leg (202, 203) is silicon nitride.

5. The sensor (200) of claim 1, wherein the microresonator (205) is a ring.

6. The sensor (200) of claim 1, wherein the microresonator (205) has a quality factor Q greater than 106.

7. The sensor (200) of claim 1, wherein the absorber (206) is a grid of metallic crosses.

8. The sensor (200) of claim 1, wherein the ridge patterned into each leg (203) has a width w less than 4 μm.

9. The sensor (200) of claim 1, wherein each leg (202, 203) has a length 1 greater than 100 μm.

10. The sensor (200) of claim 1, further comprising:
a second island (218) mechanically supported by the frame (201) with legs (210);
a second microresonator (205) on the second island (218); a second absorber (206) on the second island (218); and
a second waveguide coupler (207) on the second island (218) and a second edge coupler (214, 216) at a second end of the substrate-supported waveguide (209),
wherein the second absorber (206) is shielded by a radiation shield (219).

11. A process for detecting rapid changes in the intensity of infrared or far-infrared light comprising the steps of:
providing a bolometer-optical microresonator infrared sensor (200);
providing a tunable continuous wave laser (226) emitting light at a wavelength near 1.55 μm;
coupling light from the laser (226) to an input waveguide (227) of the sensor (200);
tuning the laser (226) such that an emission line of the laser (226) lies on the blue wing of a resonance line of a microresonator (205);
providing a photodiode (228) at an output of an output waveguide (229) of the sensor (200);
exposing the sensor to infrared or far-infrared light (230) whose intensity changes are to be measured; and
detecting changes in light intensity at the output waveguide (229) with the photodiode (228) wherein the changes are indicative of changes in intensity of the infrared or far-infrared light (230).

12. The process of claim 11, wherein the step of tuning the laser (226) comprises sweeping the laser's emission line across the microresonator's (205) resonance line from higher frequency to lower frequency.

13. The process of claim 11, wherein the sensor (200) comprises at least two legs (202, 203) mechanically supporting an island (204) relative to a frame (201), the microresonator (205) being located on the island (204).

14. The process of claim 11, further comprising modulating the laser (226) at a microwave frequency (231).

15. The process of claim 14, wherein the modulating step imposes a sideband onto the laser's emission line.

16. The process of claim 11, further comprising locking the CW laser frequency (232) to a resonance line of an external cavity (233).

17. The process of claim 11, further comprising providing a second bolometer-optical microresonator infrared sensor (218) not exposed to the infrared or far-infrared light (230).

18. The process of claim 17, further comprising locking the CW laser frequency (232) to a resonance line of the second sensor (218).

19. The process of claim 11, wherein the step of providing a photodiode (228) comprises providing a temperature-stabilized photodiode.

20. The process of claim 11, wherein at least one calculation step is performed by a computer (234) implementing an algorithm (235) to achieve a useful technical effect.
